(19) United States
(12) Patent Application Publication
(10) Pub. No.: US 2024/0419416 A1
(43) Pub. Date: Dec. 19, 2024

(54) BINARY DATA MODEL COMPILER

(71) Applicant: William Tegel, Chicago, IL (US)

(72) Inventor: William Tegel, Chicago, IL (US)

(21) Appl. No.: 18/815,116

(22) Filed: Aug. 26, 2024

Related U.S. Application Data
(63) Continuation-in-part of application No. 18/046,500, filed on Oct. 13, 2022, now Pat. No. 12,101,388.

(51) Int. Cl. G06F 8/41

(52) U.S. Cl. CPC G06F 8/41

(57) ABSTRACT

An extensible binary data model compiler is described. A receiver may receive binary specifications, binary data models and/or binary descriptions which are design documents, programming language source files, and/or interface description language definitions that describe, specify and/or model a binary communication protocol, binary data storage format, or binary data processing architecture. A categorizer may distribute binary descriptions to a respective loader, binary specifications to a respective compiler, and/or binary data models to a respective reader. Binary descriptions are normalized and compiled into generic binary models. Binary specifications are compiled into generic binary data models. A reader may read an existing binary data model. A resolver may generate a generic binary data model address for each generic binary data model element within a generic binary data model. A generic binary data model is an independent intermediate representation enabling shared analysis and operations.

### RELATED APPLICATIONS

This application is a continuation-in-part of U.S. patent application Ser. No. 18/046,500 filed on Oct. 13, 2022, which is hereby incorporated by reference in its entirety.

### TECHNICAL FIELD

Embodiments of the present disclosure relate to modeling binary communication protocols, binary data storage formats, and binary data processing architectures.

### BACKGROUND

A compiler is a program executed by a computer having processing circuitry, e.g., also referred to as computer-executable program instructions, that translates computer code written in one programming language (the source language) into another language (the target language). The name “compiler” is primarily used for programs that translate source code from a high-level programming language into a lower-level output (e.g., object code, intermediate language, assembly language, or machine code) or create an executable program. There are many different types of compilers, some of which can handle multiple types of inputs. For instance, multi-language compilers use language specific input drivers to process different source languages. Multiple input compilers typically consist of a minimum of 3 stages: a flexible front end for handling different inputs, an intermediate representation for modeling, and a back end for producing various outputs. The intermediate representation, sometimes referred to as the “middle end,” is a common model for shared analysis and processing methods. Gnu Compiler Collection (GCC) is a multi-input multi-output compiler that can handle many programming languages including C and C++. GCC's front end is a collection of language specific drivers that parse programming language source code into abstract syntax trees and convert these into a common representation called GENERIC. GENERIC is an independent intermediate representation that can represent programs written in all the languages supported by GCC. GENERIC is one of several intermediate representations within GCC that model computer programs and enable common optimization and generation facilities to be shared across multiple outputs in the back end.

Binary data is defined as data with a unit that can only be one of two possible states, usually labeled as “O” and “1” according to the binary numeral system. Binary data occurs in and/or otherwise may be used in various scientific and technical fields, e.g., in the technical field of computer science, a binary digit is referred to as a “bit”. At the lowest level, binary data is stored and processed as bits; however, modern computers rarely modify individual bits for performance reasons. Instead, binary data is aligned in groups of a fixed number of bits, usually 8 bits, called a byte, and accessed in groups of 4 or 8 bytes depending on the processing architecture. A group of bytes intended to be accessed as a single unit of information is a binary field. At higher levels, binary data is composed of binary fields arranged into records, messages, or other complex data structures. Consequently, binary data consists of a physical sequence of bytes and an explicit set of rules for interpreting those bytes as fields and other complex binary data structures.

In modern computing, most binary fields and binary data are symbolic and are therefore used to represent other forms of information. For instance, a field in a binary financial market data protocol representing a stock price may be transmitted as a 4-byte binary signed integer with 4 implicit decimal places of precision, i.e. the bytes [00000000 00001101 01010101 10101100], commonly displayed in hexadecimal format as [00 0D 55 AC], would represent a current stock price of $87.39. Binary data also refers to any data represented in binary form, and binary information is any information stored, processed, or transmitted as binary data. Three (3) primary types of binary information are commonly recognized, including: (1) binary communication protocols, (2) binary data storage formats, and (3) binary data processing architectures.

Binary communication protocols may be used to define and describe how to establish relatively efficient communication between devices, such as processing devices, processing units, and/or two or more computing devices, such as a computing system, computer, or smartphone. For example, a binary communication protocol may establish a set of rules that determine how a specific type of data is transmitted between different devices over a network. Binary communication protocols may contain complex structures composed of groups of binary fields, such as records or messages, which convey information or trigger operations. As transmission speeds and interpretation of binary communication protocols tend to be faster compared to other types of protocols, binary communication protocols may be used for applications requiring fast processing and efficient data transmission. The Internet protocol suite, commonly known as TCP/IP, includes binary communication protocols TCP (Transmission Control Protocol) and UDP (User Datagram Protocol). TCP and UDP are implemented in many programming languages and documented in many places.

Binary data storage or file formats may be used to define and describe how to encode information for storage on a computing system or computing device. For example, in one or more embodiments, binary file formats may store data in a non-transitory computer-readable medium. Binary data storage and file formats may be more compact, efficient and machine readable than other storage formats. Some binary file formats are designed for specific types of data. For example, PCAP files store data recorded by computer network traffic capture interfaces. Binary file formats often have published documentation describing the binary fields and the binary field layout.

Binary data processing architectures use digital logic to interpret and execute programming instructions and perform arithmetic operations. For example, a microprocessor is a digital electric circuit that accepts binary data as input, processes it according to instructions stored in its memory and provides results in binary form. Binary data processing architectures may use hardware description languages (HDL) such as Verilog to define and describe how computing devices process information. An HDL is a specialized computer language used to describe the structure and behavior of electronic circuits, and most commonly, digital logic circuits. HDL enables a precise, formal description of an electronic circuit that allows for the automated analysis and simulation of the electronic circuit.

Binary descriptions are technical notes, design documents or programming language source code created to describe, document, or implement various aspects of a binary communication protocol, binary data storage format, and/or a binary data processing architecture. Binary descriptions, which exist in many different formats, can be human or machine readable. For instance, National Association of Security Dealers Automated Quotations (NASDAQ) TotalView-ITCH (ITCH), a high-performance binary protocol promulgated by NASDAQ for broadcasting financial market data, is disseminated in multiple PDFs (Portable Document Format) each of which has a different format. Common binary communication protocols, like UDP and TCP, will have many corresponding binary design documents and implementations in programming languages such as C++, Java, Python, etc. Additionally, there are many interface description languages (IDL) which are domain specific languages that provide specific “grammars” (i.e. syntaxes) optimized for representing specific fields and structures. IDLs often can be translated directly into programming language source code for encoding and decoding binary data. Examples of binary data IDLs are ASN.1 (Abstract Syntax Notation One), Simple Binary Encoding (SBE), Kaitai Struct, etc. Several futures exchanges use SBE binary communication protocols for trading, with SBE binary descriptions distributed in various versioned XML (Extensible Markup Language) formats.

A binary specification describes the required set of binary fields and rules for encoding/decoding a binary communication protocol, binary data storage format, and/or binary data processing architecture. Binary specifications can be assembled from one or more binary descriptions. Binary specifications not only include the instructions for interpreting binary fields, but also the rules for interpreting binary messages, other complex data structures, and mutable data like variable length fields.

Source code may be generated based on the technical details provided in the documentation used to implement and/or describe binary communication protocols, binary data storage formats, and binary data processing architectures.

However, there are some drawbacks associated with generating source code based on the provided documentation for binary communication protocols, binary data storage formats, and binary data processing architectures. For example, the binary descriptions that describe binary communication protocols tend to be imperfect. That is, binary protocol descriptions typically contain highly technical and complex information, have incorrect information, and/or are missing details. Generating source code based on the binary descriptions typically requires some development to be performed manually, making the source code generation process tedious, laborious, and error prone.

Further, binary communication protocols (and, therefore, the corresponding binary protocol descriptions and specifications) may be updated or replaced requiring additional source code to be generated. Many applications use multiple binary protocols associated with different transfer layers (e.g., Internet protocol suite) requiring a relatively large amount of source code to be manually written in each applicable source code programming language.

Prior art binary communication protocol modeling techniques attempting to address the above drawbacks have proven ineffective, inefficient, and/or unsatisfactory. For example, prior art binary communication protocol modeling techniques are language-dependent, platform-dependent, use declarative languages with specific grammars to manually describe binary fields and binary data structures (e.g., users are required to manually describe binary data structures in a custom programming language before being compiled into custom source code), are non-extensible, and/or require manual translation of binary descriptions into user-defined definitions stored in a database.

Although the present disclosure discloses the invention primarily in the context of binary communication protocols, the invention is similarly applicable to modeling other binary information such as binary data storage formats and binary data processing architectures, which have similar drawbacks.

### SUMMARY

A generic binary data model compiler and methods for creating generic binary data models of the present disclosure improve on prior art binary data modeling in various significant ways. For example, the generic binary data model compilers of the present disclosure may reduce the use of declarative languages to predefine binary data structures, eliminate custom translations of binary communication protocols into language-specific definitions, and/or provide an independent intermediate representation for common analysis and thereby facilitate more efficient binary data model processing (e.g., faster and more accurate processing), as well as more efficient and flexible manipulation of data contained in the binary data models. In addition, the generic binary data model compilers of the present disclosure may facilitate access to binary data via binary data model element addresses and, since elementary components are composable and extensible, data contained in the generic binary data models may be highly customizable.

Additionally, the generic binary data model compiler of the present disclosure may create flexible, platform-independent, language-independent, and extensible generic binary data models for representing arbitrary binary communication protocols, binary data storage formats, and binary data processing architectures.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a block diagram of an exemplary embodiment of an exemplary generic binary data model compiler for creating a generic binary data model from a normalized binary specification.

FIG. 2 illustrates a diagram of an exemplary embodiment for transforming a universal binary specification for a generic ITCH binary communication protocol into its respective generic binary data model.

FIG. 3A illustrates a block diagram of an exemplary embodiment of a compiler for parsing, verifying, and loading a universal binary specification and iteratively creating a generic binary data model from the components of a universal binary specification.

FIG. 3B illustrates a block diagram of an exemplary embodiment of another compiler for parsing, verifying, and loading binary specifications (other than the universal binary specification) and iteratively creating a generic binary data model.

FIG. 4 illustrates a block diagram of an exemplary embodiment of a system incorporating various binary data model compilers shown by FIGS. 3A-3B into a multiple input compiler for converting any binary specification that includes the required binary fields and rules for a binary communication protocol, binary data storage format, and/or binary data processing architecture into a generic binary data model.

FIG. 5 illustrates a block diagram of a generic binary data model as an independent intermediate representation for modeling arbitrary binary communication protocols, binary data storage formats, and/or binary data processing architectures.

FIG. 6 illustrates a block diagram of an exemplary embodiment of various categories of input specific drivers of the front end of a multiple input binary data model compiler.

FIG. 7 illustrates a block diagram of an exemplary embodiment of a system for receiving binary descriptions, binary specifications and binary data models and creating generic binary data models for further processing and analysis.

FIG. 8A illustrates a block diagram of an exemplary machine for creating exemplary generic binary data models using the binary data model compiler shown in either FIG. 3A or FIG. 3B.

FIG. 8B illustrates a block diagram of an exemplary machine for creating exemplary generic binary data models using the multiple input binary data model compiler shown in FIG. 7.

FIG. 9 illustrates a flow chart for iteratively building an exemplary generic binary data model.

FIG. 10 illustrates a flow chart for the binary data model compiler iterator when building an exemplary generic binary data model.

FIG. 11 illustrates a flow chart for receiving binary descriptions, binary specifications and binary data models as the inputs to a comprehensive front end for a compiler for reading and creating generic binary data models for further processing and analysis.

FIG. 12 illustrates a schematic diagram of an exemplary embodiment of sequential interpretation of binary data fields using binary data model element type traits to decode binary fields in an example ITCH binary communication protocol.

FIG. 13 illustrates a schematic diagram of an exemplary embodiment of a composite type with a runtime binary rule with a dependency from an example SBE XML.

FIG. 14 illustrates a schematic diagram of an exemplary embodiment of a binary data model action combining fields from multiple binary messages to create a composite timestamp.

### DETAILED DESCRIPTION

The present disclosure discloses the invention in the context of generic binary data models representing binary communication protocols. However, the principles described herein are fully applicable to all types of binary information including, not only binary communication protocols, but also binary data storage formats and binary data processing architectures. Thus, although the present disclosure uses as examples binary communication protocols such as TCP, UDP and ITCH and their corresponding normalized binary descriptions and/or universal binary specifications, the principles disclosed herein are applicable to other binary descriptions including technical notes, design documents, programming language source code (C++, C, Java, SQL, Python, etc.) and IDL definitions (ASN.1, Kaitai Struct, SBE, etc.).

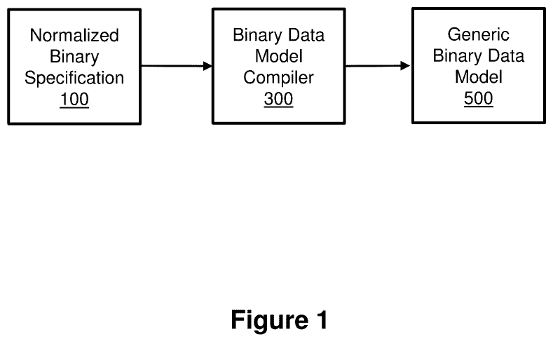

FIG. 1 illustrates a block diagram of a system incorporating a binary specification 100, a binary data model compiler 300, and a binary data model 500. A binary specification, which may describe the binary fields and required set of binary encoding/decoding rules of any one or more of a binary communication protocol, a binary data storage format and/or a binary data processing architecture, is able to be compiled into a generic binary data model. Normalized binary specification components may be fashioned into generic binary data model elements and formed into a generic binary data model using information from binary specification component identifiers or other identifying information.

For a universal binary specification with normalized binary specification component identifiers, a compiler, such as the binary data model compiler 300, can construct a generic binary data model from normalized binary specification components. Normalized binary specification components of a universal binary specification, which maybe normalized binary specification groups, normalized binary specification types, normalized binary specification rules, normalized binary specification values, and/or normalized binary specification actions may be transformed from universal binary specification components into generic binary data model elements and formed into a generic binary data model using information from normalized binary specification component identifiers. A normalized binary specification such as the universal binary specification can be aggregated from one or many binary descriptions. Binary descriptions can be plain text, PDFs, XMLs, programming language source code (C++, Java, Python, etc.), IDL definitions (ASN.1, SBE, etc.), websites, etc. A universal binary specification contains deconstructed empirical components of a binary communication protocol, binary data storage format or binary data processing architecture. A universal binary specification may be assembled and output to a common format in text, XML, JSON or another format. An exemplary process for assembling and outputting a universal binary specification to a common format is described in detail in U.S. patent application Ser. No. 18/046,500 filed on Oct. 13, 2022, which is subject to assignment to the applicant of the present application and thereby incorporated by reference in its entirety.

Still referring to FIG. 1, a binary data model compiler 300 is configured to receive the normalized binary specification 100 to, for example, perform one or more processes thereon, such as by transforming a specific type of normalized binary specification into a generic binary data model 500. A generic binary data model, such as the binary data model 500, may be or otherwise provide an independent intermediate representation for modeling binary communication protocols, binary data storage formats and/or binary data processing architectures. Generic binary data models can be progressed toward other types of data analytical techniques and manipulation methods, such as (but not limited to) one or more types of common analyses, data manipulation or source generation processes, or output to a common format for relatively fast reloading.

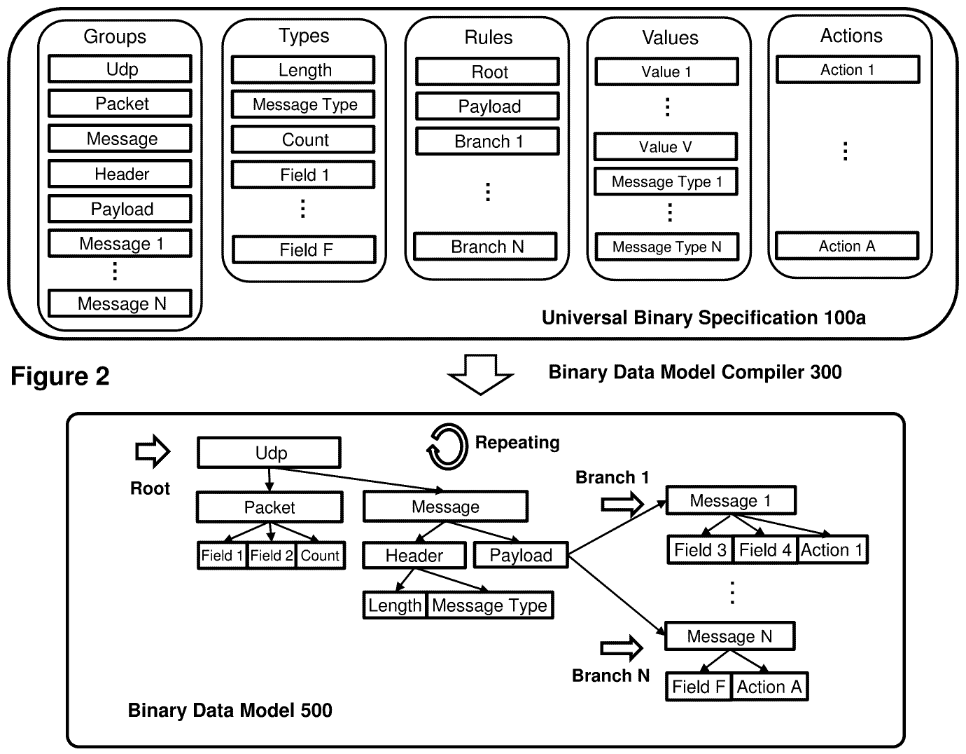

Referring now to FIG. 2, an example of the binary model compiler 300 of FIG. 1 is shown such that the binary model compiler 300 is used to form a generic binary data model from a universal normalized specification 100a. Universal normalized specification 100a in FIG. 2 is a depiction of a normalized binary specification for a generic (i.e., non-specific) ITCH UDP binary communication protocol. Universal normalized specification 100a contains the lists of normalized binary specification components as described in detail in U.S. patent application Ser. No. 18/046,500 filed on Oct. 13, 2022, for a generic ITCH UDP binary communication protocol. Universal binary specification 100a for generic ITCH UDP binary communication protocol contains normalized binary specification groups for binary ITCH packet and ITCH message headers, and a number N of ITCH messages. Additionally, a universal binary specification 100a for a generic ITCH UDP binary communication protocol may contain a normalized binary specification rule for a UDP root, a normalized binary specification rule for decoding one or more ITCH messages within an ITCH packet, as well as a normalized binary specification branch rule for each ITCH message. A universal binary specification 100a for an ITCH UDP binary communication protocol contains normalized binary specification types and normalized binary specification values for all binary ITCH header and ITCH message fields. A universal binary specification 100a for ITCH UDP binary communication protocol may contain normalized binary specification actions. The binary model compiler 300 is used to fashion a generic binary data model from the normalized binary specification components of the universal normalized specification using normalized binary specification component identifiers. Generic binary data model 500 of FIG. 2 demonstrates the tree structure of the generic binary data model compiled from the universal normalized specification 100a for the illustrated ITCH UDP binary communication protocol. In one or more embodiments, a generic binary data model may include a “tree” or trees of binary data model elements, any one or more of which may represent the complete technical details for interpreting the physical sequence of bytes of a binary communication protocol, binary data storage format or binary data processing architecture. Specifically, in the technical field of computer science, and as referred to herein in connection with any one or more of the described embodiments, a tree is a widely used data type that represents a hierarchical tree structure with a set of connected elements. Each element in the tree can be connected to multiple descendant elements, which may be referred to “children,” but must be connected to exactly one parent, except for the root element, which has no parent (i.e., the root node as the top-most element in the tree hierarchy). These constraints indicate that there are no cycles or loops”, such that no element can be its own ancestor, and that each child can be treated like the parent node of its own subtree. The elements of the generic binary data model consist of the defined binary data fields, the types and sizes of these binary data fields, and the dynamic rules for the sequential interpretation of the binary data fields. Generic binary data models may optionally include binary actions. Generic binary data models contain not only the technical instructions for encoding and decoding the bytes associated with the binary data but also the properties and characteristics differentiating the binary data fields, the complex binary structures such as messages and headers, binary decoding rules, and binary model details, etc. which can be used for analysis.

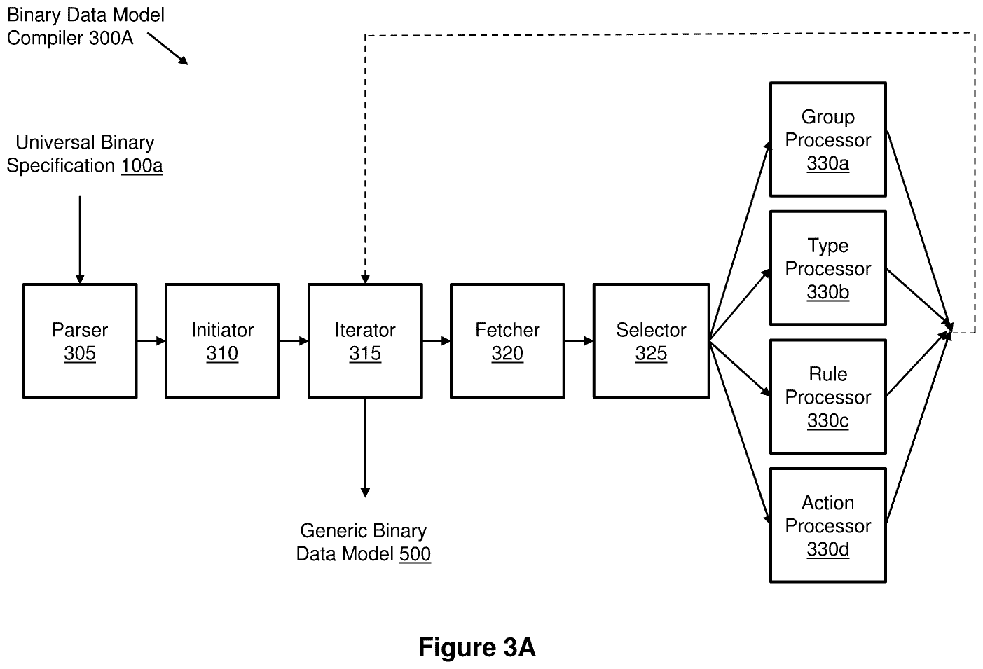

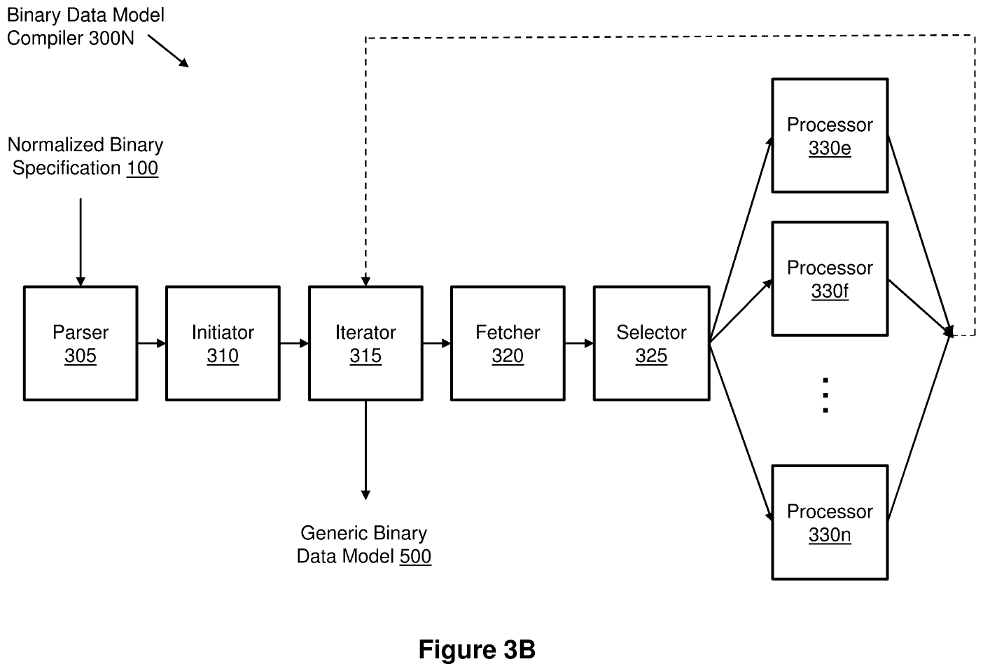

Referring now collectively to FIGS. 3A and 3B, block diagrams of exemplary binary data model compilers 300A and 300N, respectively, are shown. In FIG. 3A, the binary data model compiler 300A is a compiler specifically designed to receive a universal binary specification model as described in U.S. patent application Ser. No. 18/046,500 filed on Oct. 13, 2022. The compiler of FIG. 3A transforms a universal binary specification into a generic binary data model. The binary data model compiler 300N, alternatively, is a binary data model compiler that may receive binary specifications other than the universal binary specification model of the U.S. patent application Ser. No. 18/046,500.

Referring now to FIG. 3A, the binary data model compiler 300A may include a parser 305, which, in one or more embodiments, may be an example of a compiler component that loads, parses, and verifies the universal binary specification of U.S. patent application Ser. No. 18/046,500. Specifically, the parser 305 may receive the universal binary specification, verify the universal binary specification, and parse and/or load the universal binary specification into binary specification components. The binary data model compiler 300A may also include an initiator 310, referring to a compiler component that locates the start points of the binary data model and initializes the unprocessed binary specification component identifier list and the iterator 315. The initiator 310 may identify the initial binary specification components, such as one or more start points, from one or more components of the universal binary specification as the first start point of a binary data model and add the identifier of the first binary specification component as a current binary specification component identifier to the unprocessed binary specification component identifier processing list for the first entry point.

The binary data model compiler 300A may also include an iterator 315, a compiler component that processes the unprocessed binary specification component identifiers one at a time in order until there are no more components to process. The binary data model compiler 300A may also include a fetcher 320, a compiler component that obtains or gathers the relevant binary specification components (normalized binary specification groups, normalized binary specification types, normalized binary specification rules, normalized binary specification values, and/or normalized binary specification actions) based on the binary specification component identifier or other identifying information. Specifically, in one or more embodiments, the fetcher 320 may gather binary specification components based on an assigned identifier or other identifying information. The binary model compiler 300A may also include a selector 325, a compiler component that determines which processor to use to process the current binary specification component. Thus, the selector 325 may determine an appropriate processor to process for a given binary specification component based on the type of binary specification component. For example, if the current binary specification component is a normalized binary specification rule, selector 325 selects the binary specification rule processor 330c.

The binary data model compiler 300A may also include processors 330. A binary data model compiler processor is a compiler component that fashions, e.g., defined as to make into a particular or required form, one or more elements of the generic binary data model based on a binary specification component. Processors 330 are configured to create generic binary model elements based on normalized binary specification component type. In the illustrated embodiment, the binary data model compiler 300A includes a normalized binary specification group processor 330a, a normalized binary specification type processor 330b, a normalized binary specification rule processor 330c, and a normalized binary specification action processor 330d. Once an unprocessed binary specification component has been processed, the iterator 325 may iteratively repeat the above-described process for binary specification components in the unprocessed binary component identifier processing list incrementally, e.g., one at a time, until there are no more binary specification components to be processed, resulting in a complete generic binary data tree. In one or more embodiments, the resulting complete generic binary data model tree may be configured as and/or otherwise generated with a “tree” structure, e.g., such as the tree structures described earlier in this disclosure. A generic binary data model consists of one or more binary data model trees and the generic binary data model details, which usually include but are not limited to the organization, protocol, type, version of the corresponding binary communication protocol, binary data storage format or binary data processing architecture.

Still referring to FIG. 3A, the normalized binary specification group processor 330a of the binary data model compiler 300A may, in one or more embodiments, receive a normalized binary specification group of the universal binary specification and the location of its parent binary data model element within the generic binary data model tree. The normalized binary specification group processor 330a of the binary data model compiler 300A fashions a generic binary group model element based on the properties of the normalized binary specification group and converts any normalized binary specification traits to binary data model traits and any normalized binary specification characteristics to binary data model element characteristics for the generic binary model group element. The normalized binary specification group processor 330a of the binary data model compiler 300A fetches any relevant normalized binary specification values, relevant normalized binary specification rules, and relevant normalized binary specification actions that match the identifier of the normalized binary specification group of the universal binary specification. The normalized binary specification group processor 330a of the binary data model compiler 300A converts the relevant normalized binary specific values to binary data model values, relevant normalized binary specific rules to binary data model rules and relevant normalized binary specification actions to binary data model actions of the new generic binary data model group element and adds the new binary data model group element to the current generic binary model tree as the next child element of the corresponding parent binary data model element at the provided location within the generic binary data model tree. Finally, for each binary field of the normalized binary specification group fields list of the normalized binary specification group, the binary specification group processor 330a of the binary data model compiler 300A adds the corresponding binary specification component identifier of the binary specification group field and the location of the new binary group model element as the parent binary data model element to the unprocessed binary specification component processing list in sequential order of the normalized binary specification group fields list.

The normalized binary specification type processor 330b of the binary data model compiler 300A receives a normalized binary specification type of the universal binary specification and the location of its parent binary data model element within the generic binary data model tree. The normalized binary specification type processor 330b of the binary data model compiler 300A fashions a generic binary model type element based on the properties of the normalized binary specification type and converts all normalized binary specification traits to binary data model traits and any normalized binary specification characteristics to binary data model element characteristics for the generic binary model type element. The normalized binary specification type processor 330b of the binary data model compiler 300A fetches any relevant normalized binary specification values, relevant normalized binary specification rules, and relevant normalized binary specification actions that match the identifier of the normalized binary specification type of the universal binary specification. The normalized binary specification type processor 330b of the binary data model compiler 300A converts the relevant normalized binary specific values to binary data model values, relevant normalized binary specification rules to binary data model rules, and relevant normalized binary specification actions to binary data model actions of the new generic binary data model type element and adds the new binary data model type element as the next child element of the binary data model parent element at the provided location within the current generic binary data model tree. The binary specification type processor 330b of the binary data model compiler 300A adds no normalized binary specification components to the unprocessed binary specification component processing list.

The normalized binary specification rule processor 330c of the binary data model compiler 300A receives a normalized binary specification rule of the universal binary specification and the location of its parent binary data model element within the generic binary data model tree. The normalized binary specification rule processor 330c of the binary data model compiler 300A fashions a generic binary model rule element based on the properties of the normalized binary specification rule and converts any normalized binary specification rule parameters to generic binary data model rule element parameters and any normalized binary specification characteristics to binary data model element characteristics for the generic binary model rule element. The normalized binary specification rule processor 330c of the binary data model compiler 300A fetches any relevant normalized binary specification values that match the identifier of the normalized binary specification rule and converts the relevant normalized binary specific values to generic binary data model values of the generic binary model rule element and adds the new generic binary data model rule element as the next child element of the parent binary data model element at the provided location within the current generic binary data model tree. The normalized binary specification rule processor 330c of the binary data model compiler 300A fetches any other normalized binary specification rules that match the identifier of the normalized binary specification rule of the universal binary specification. For a binary data model rule of Type: Branch, the normalized binary rule processor 330c of the binary data model compiler 300A resolves any branch binary dependencies and adds the binary specification component identifiers of the binary dependencies and the location of the new binary model rule element as the parent binary data model element within the generic binary data model to the unprocessed binary specification component processing list in the sequential order of the fetched normalized binary specification rules of the universal binary specification. For a binary data model rule of Type: Union, the normalized binary rule processor 330c of the binary data model compiler 300A resolves any union binary dependencies and adds the binary specification component identifiers of the binary dependencies and the location of the new binary model rule element as the parent binary data model element within the generic binary data model to the unprocessed binary specification component processing list in the sequential order of the fetched normalized binary specification rules of the universal binary specification.

The normalized binary specification action processor 330d of the binary data model compiler 300A receives a normalized binary specification action of the universal binary specification and the location of its parent binary data model element within the generic binary data model tree. The normalized binary specification action processor 330d of the binary data model compiler 300A fashions a generic binary action model element based on the properties of the normalized binary specification action and converts any normalized binary specification action instructions to generic binary data model element instructions and any normalized binary specification characteristics to binary data model element characteristics for the generic binary model action element. The normalized binary specification action processor 330d of the binary data model compiler 300A fetches any relevant normalized binary specification values that match the identifier of the normalized binary specification action of the universal binary specification. The normalized binary specification action processor 330d of the binary data model compiler 300A converts the relevant normalized binary specific values to binary data model values of the new generic binary data model action element and adds the new binary data model action element to the existing generic binary model at the corresponding binary data model parent element location.

If the fetcher 320 of FIG. 3A, fails to obtain any corresponding binary specification components using the binary specification component identifier or other identifying information, an empty placeholder binary data model element containing the binary specification component identifier is added to the existing generic binary model at the corresponding binary data model parent element location.

Still referring to FIG. 3A, the iterator 315 repeats the above-described process for binary specification components in the unprocessed binary component processing list one at a time until there are no more binary specification components to be processed. A binary data model tree is complete once the unprocessed binary component processing list is fully consumed, e.g., made empty.

A generic binary data model may contain multiple binary data model element trees. If the universal binary specification contains more than one start point, the above process is repeated until every binary data model element tree's unprocessed binary specification component list contains no more binary specification components. For example, NASDAQ TotalView-ITCH broadcasts binary market data messages over UDP for high performance order book updates and separately maintains TCP sessions for order book snapshot and recovery of binary market data messages. The NASDAQ TotalView-ITCH TCP snapshots may contain more and different messages than the NASDAQ TotalView-ITCH UDP market data updates. Consequently, modelling the NASDAQ TotalView-ITCH binary communication protocol requires distinct binary data model trees for both UDP and TCP. For a NASDAQ TotalView-ITCH universal binary specification that contains a normalized binary specification rule for UDP packet start point and a normalized binary specification rule for TCP packet start point, the iterator 315 completes the above-described process once for each start point, thereby creating generic binary data model with two binary data model element trees.

Binary data models, such as the generic binary data model 500 shown in FIGS. 1 and 2, and referred to throughout the present disclosure, may be one or more trees of binary data model elements, representing the physical relationships between binary data fields and the sequences of bits and bytes that compose, e.g., make up, the binary data fields. The relationships between binary data fields can be described by binary data model groups and a limited set of binary data rules. Specifically, in one or more embodiments, binary data model rules may include any one or more of the following, which may be used in the generic binary data models described in the present disclosure. Specifically, such described binary data model rules may include:

Root: Referring to a start point of binary data model tree. Binary model rules for root elements may include the type of binary data model tree. For example, in one or more embodiments, generic binary data models can have multiple roots. An example of a binary communication protocol with multiple roots is NASDAQ TotalView-ITCH which contains different messages for UDP and TCP communication.

Branch: Referring to a binary field or group that may be determined at processing time using the information in another binary field. For example, a binary communication protocol with multiple messages uses binary branch rules to describe the logic for choosing which message to process.

Union: Referring to the concept that one of several predefined types can share the same, e.g., a common, data field. In one or more embodiments, the size of the binary union field may be the size of the largest predefined types. Field interpretation may be determined at processing time using the information in another binary field.

Count: Referring to a binary element that repeats a number of times. In one or more embodiments, binary count rules can be either static or dynamic, where dynamic counts of binary fields must be determined at a processing time from other binary fields or information. For example, a message with repeating groups of fields may have a variable number of repetitions such that the number of repetitions may be conveyed by another binary field.

Size: Referring to binary element size, usually a count of bytes or bits, which must be determined at processing time from prior fields or information. Static sized fields are described through binary type traits. A variable length text field where the number of bytes is contained in preceding field is an example of a binary size rule.

Data: Referring to a block of data, which can be filed with one or more repeating elements, and parsing the data block until all bits/bytes have been read. The number of bytes/bits may be determined at processing time from the information in other binary fields or other information such as a sentinel value. Sometimes referred to as a block, payload, and/or stream. For example, a binary communication protocol with multiple messages might require parsing a block of bytes until all the bytes have been parsed.

Conditional: Referring to a binary field or group's optional inclusion or exclusion determined at processing time from the information in other binary fields. For example, a binary message that has an optional appendage can be modeled using a binary data model rule with Type: Conditional.

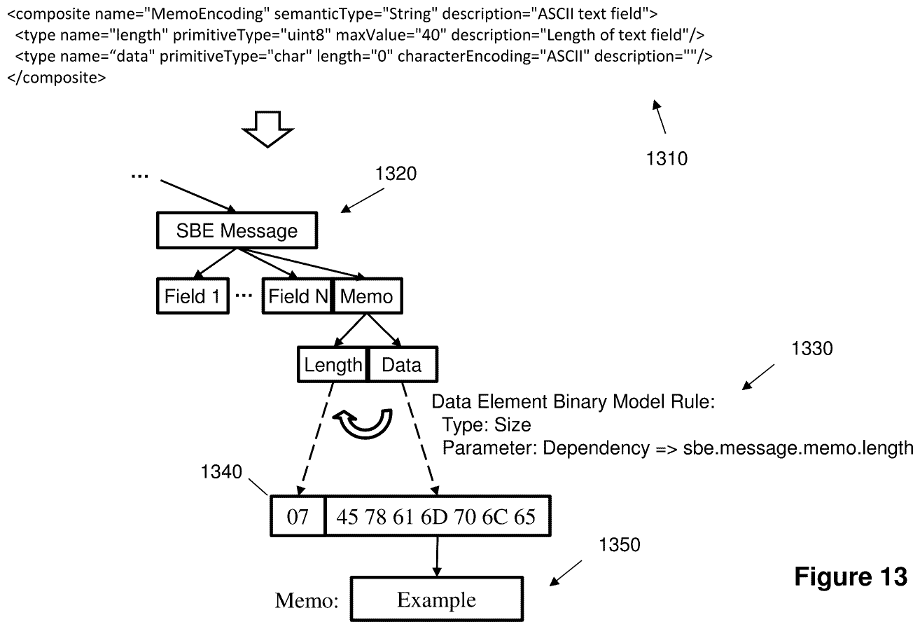

Existing binary communication protocols, binary data storage formats, and binary processing architectures contain a relatively large number of distinct instances of binary data rules. Binary data model rules are made extensible by one or more binary model rule parameters. Binary data model rules can model the encoding and decoding of the sequential bytes of arbitrary binary data storage formats, and binary processing architectures when customized by one or more binary data model rule parameters. For instance, if the decodable size in bytes of a variable length binary field is contained in a different binary field, the binary field that contains the number of bytes of the variable length binary field will need to be interpreted to interpret the variable length binary field. A binary field that is required for interpreting or decoding another binary field is referred to as a “dependency” or “binary dependency” and many binary rule parameters contain dependencies. An example of a binary dependency is shown in connection with at least FIG. 13 of the present disclosure. Within SBE XML elements 1310 in FIG. 13, the binary field with XML attributes name=“data” and length=“0”, has a variable length. The grammar of this format of SBE XML requires that the size in bytes of the variable length binary field with XML attributes name=“data” and length=“0” is encoded in the binary field with XML attributes name=“length” and primitiveType=“uint8.” SBE XML elements may be converted into normalized binary specification components as described in detail in U.S. patent application Ser. No. 18/046,500 filed on Oct. 13, 2022 and compiled into generic binary data model elements according to the process described above in FIG. 3A. For the binary field with XML attributes name=“data” and length=“0” as declared in SBE XML elements 1310 of FIG. 13, a corresponding generic binary data model element representing the binary data field Name: “Data” will contain a binary data model rule of Type: Size with a binary model rule parameter with Type: Dependency and the information required to locate generic binary data model element with Name: “Length” within the binary data model tree.

In some instances, multiple binary rule parameters are required for fully implementing a binary data model rule. For example, in one embodiment, the number of bytes of an ITCH message is transmitted in the binary field with Name “Length.” However, the ITCH binary field with Name “Length” may contain the number of bytes of the following binary ITCH message including the number of bytes of the first ITCH message header field. In this case, additional binary data model rule parameters can specify the difference between the number of bytes stored in the field with Name: “Length” and the actual number of bytes expected when interpreting the binary ITCH message.

In addition to that described here or elsewhere in the present disclosure, in one or more embodiments, binary data model elements within the generic binary data model may constitute one or more “composite or “compound” types. A binary data model group may contain one or more child binary data fields that can be aggregated and processed as a single binary field. One version of a composite type is a binary field constructed from its child fields. For example, the SBE Memo field of FIG. 13 is a composite field. In FIG. 13, the SBE binary field with XML attributes name=“MemoEncoding” and description=“ASCII text field” is a variable length ASCII text field with two child binary fields. The child binary field with XML attributes name=“data” and length=“0” as declared and described in SBE XML elements 1310, contains the text and the child binary field with XML attributes name=“length” and primitiveType=“uint8” contains the number of bytes of the variable length binary field. SBE XML elements may be converted into normalized binary specification components as described in detail in U.S. patent application Ser. No. 18/046,500 filed on Oct. 13, 2022 and compiled into generic binary data model elements according to the method shown in FIG. 3A. For the SBE binary field with XML attributes name=“MemoEncoding” with child SBE fields with respective XML attributes name=“length” and name=“data”, a corresponding generic binary data model group element with Name: “Memo” and two corresponding child binary data model type elements representing the binary data fields Name: “Data” and Name: “Length” may exist within the generic binary data model tree for the SBE binary communication protocol. For a programming language that includes a fundamental string type for storing and manipulating text, programming language source code can be generated to automatically calculate the length in bytes of the text to be sent via the SBE binary communication protocol with a SBE composite Memo field using the generic binary data model group element with Name: “Memo” and the properties of the child generic binary data model type elements with Name: “Data” and Name: “Length.” Other methods for representing composite types may exist. For example, the parent binary data group element might contain separate and different binary type traits for interpreting bytes independently from any child binary data fields.

Many stock exchanges use a custom version of NASDAQ's ITCH protocol to disseminate market data via TCP and UDP. An example ITCH universal binary specification with 2 binary messages created using the process outlined in U.S. patent application Ser. No. 18/046,500 filed on Oct. 13, 2022, is included below. The details of the example ITCH binary communication protocol are listed first, followed by normalized binary components. The normalized binary components of the example ITCH universal binary specification are normalized binary types, normalized binary groups, normalized binary rules, normalized binary values, and normalized binary actions which are listed by normalized component type [identifier] followed by the normalized binary component properties.

### Organization:

Name: The Open Markets Initiative
Abbreviation: Omi

### Division:

Name: Market Data Protocols
Abbreviation: Protocols

### Protocol:

Name: Integrated Trading Channel Handlers
Abbreviation: Itch

### Data:

Name: Two Message Example
Abbreviation: Example
Encoding: Binary

### Version:

Major: 1
Minor: 0

### Details:

Testing: Verified

### Document:

Type: url
Url: https://github.com/Open-Markets-Initiative
   Type [instrument]
Name: Instrument
Description: Identifier of the instrument

### Traits:

Size: 4
Translation: Integer
Signedness: Unsigned
Memory: Bytes
Endian: Big
   Type [messagecount]
Name: Message Count
Description: Number of messages to follow this header
Traits:
   Size: 2
   Translation: Integer
   Signedness: Unsigned
   Memory: Bytes
   Endian: Big
      Type [messagelength]
Name: Message Length
Description: Length of data message not including this field
Traits:
   Size: 2
   Translation: Integer
   Signedness: Unsigned
   Memory: Bytes
   Endian: Big
      Type [messagetype]
Name: Message Type
Description: Code identifying this message type
Traits:
   Size: 1
   Translation: Ascii
   Memory: Bytes
      Type [orderid]
Name: Order Id
Description: Public id of the order

### Traits:

Size: 8
Translation: Integer
Signedness: Unsigned
Memory: Bytes
Endian: Big
   Type [orderpriority]
Name: Order Priority
Description: Time priority of this order within the order book

### Traits:

Size: 8
Translation: Integer
Signedness: Unsigned
Memory: Bytes
Endian: Big
   Type [price]
Name: Price
Description: Price of the order
Traits:
   Size: 8
   Translation: Integer
   Signedness: Signed
   Memory: Bytes
   Endian: Big
      Type [quantity]
Name: Quantity
Description: Number of lots added to the book
Traits:
   Size: 4
   Translation: Integer
   Signedness: Unsigned
   Memory: Bytes
   Endian: Big
      Type [seconds]
Name: Seconds
Description: Seconds from start of Unix Epoch
Traits:
   Size: 4
   Translation: Integer
   Signedness: Unsigned
   Memory: Bytes
   Endian: Big
   Timestamp: Seconds
   Epoch: Unix
      Type [sequencenumber]
Name: Sequence Number
Description: Sequence number of the first message
Traits:
   Size: 8
   Translation: Integer
   Signedness: Unsigned
   Memory: Bytes
   Endian: Big
      Type [session]
Name: Session
Description: Identity of the multicast session
Traits:
   Size: 10
   Translation: Ascii
   Memory: Bytes
   Justified: Right
   Fill: Zeros
      Type [side]
Name: Side
Description: Type of order
Traits:
Size: 1
Memory: Bytes
Translation: Ascii
   Type [timestamp]
Name: Timestamp
Description: Nanoseconds portion of the timestamp
Traits:
   Size: 4
   Translation: Integer
   Signedness: Unsigned
   Memory: Bytes
   Endian: Big
   Timestamp: Nanoseconds
   Epoch: Second
      Type [tradedate]
Name: Trade Date
Description: Trade Date
Traits:
   Size: 2
   Translation: Integer
   Signedness: Unsigned
   Memory: Bytes
   Endian: Big
   Date: Days
   Epoch: Unix
      Group [addordermessage]
Name: Add Order Message
Description: New order or a restated order
Fields:
   1: timestamp
   2: tradedate
   3: instrument
   4: side
   5: ORDERED
   6: ORDERPRIORITY
   7: QUANTITY
   8: PRICE
Characteristics:
   Classification: Message
   Book: Add
      Group [header]
Name: Header
Description: Example ITCH message header
Fields:
   1: messagelength
   2: messagetype
Characteristics:
   Classification: Header
      Group [message]
Name: Message
Description: Example ITCH message
Fields:
   1: header
   2: payload
      Group [packet]
Name: Packet
Description: Example ITCH UDP packet header
Fields:
   1: session
   2: sequencenumber
   3: messagecount
Characteristics:
   Classification: Header
      Group [secondsmessage]
Name: Seconds Message
Description: Seconds message is issued every second
Fields:
   1: seconds
Characteristics:
   Classification: Message
   System: Timestamp
      Group [udp]
Name: Udp
Description: Example ITCH UDP packet
Fields:
   1: packet
   2: message
      Value [side]
Type: Enum
Name: Sell
Value: S
Description: Sell Order
   Value [side]
Type: Enum
Name: Buy
Value: B
Description: Buy Order
   Value [messagetype]
Type: Enum
Name: Seconds Message
Value: T
Description: Seconds Message
   Value [messagetype]
Type: Enum
Name: Add Order Message
Value: A
Description: Order Added Message
   Rule [message]
Type: Count
Description: ITCH UDP packet message count
Parameters:
   Dependency: messagecount
      Rule [message]
Type: Data
Description: ITCH message data block
Parameters:
   Buffer: Rest
      Rule [payload]
Type: Branch
Description: Seconds Message branch
Parameters:
   Dependency: messagetype
   Operator: Equals
   Data: T
   Branch: secondsmessage
      Rule [payload]
Type: Branch
Description: Order Added Message branch
Parameters:
   Dependency: messagetype
   Operator: Equals
   Data: A
   Branch: addordermessage
      Rule [udp]
Type: Root
Description: Example ITCH UDP packet root
Parameters:
   Transport: Udp
   Packet: udp
      Action [header]
Type: Increment
Description: Message sequence number
Instructions:
   Dependency: sequencenumber
   Name: Sequence Number
      Action [timestamp]
Type: Composite
Description: Composite timestamp
Instructions:
   Timestamp: Seconds
   Dependency: seconds

The above example ITCH universal binary specification may be compiled into a generic binary data model representing the example ITCH binary communication protocol using the binary data model compiler 300A, as illustrated in FIG. 3A. The following are the stepwise iterations of the binary data model compiler 300A compiling the example ITCH universal binary specification into a generic binary data model:
[Step 1] Locate start point: udp
   Adding start point to unprocessed list: udp
[Step 2] Fetch binary specification components for: udp
   Name: Udp, Fields: 2, Rules: 1
   Select binary specification group processor
   Binary data model address for Udp element: udp
   Adding fields for Udp to unprocessed list: packet, message
   Unprocessed binary specification components: packet, message
[Step 3] Fetch binary specification components for: packet
   Name: Packet, Fields: 3
   Select binary specification group processor
   Binary data model address for Packet element: udp.packet
   Adding fields for Packet to unprocessed list: session, sequencenumber, messagecount
   Unprocessed binary specification components: session, sequencenumber, messagecount, message
[Step 4] Fetch binary specification components for: session
   Name: Session
   Select binary specification type processor
   Binary data model address for Session element: udp.packet.session
   Unprocessed binary specification components: sequencenumber, messagecount, message
[Step 5] Fetch binary specification components for: sequencenumber
   Name: Sequence Number
   Select binary specification type processor
   Binary data model address for Sequence Number element: udp.packet.sequencenumber
   Unprocessed binary specification components: messagecount, message
[Step 6] Fetch binary specification components for: messagecount
   Name: Message Count
   Select binary specification type processor
   Binary data model address for Message Count element: udp.packet.messagecount
   Unprocessed binary specification components: message
[Step 7] Fetch binary specification components for: message
   Name: Message, Fields: 2, Rules: 2
   Select binary specification group processor
   Binary data model address for Message element: udp.message
   Adding fields for Message to unprocessed list: header, payload
   Unprocessed binary specification components: header, payload
[Step 8] Fetch binary specification components for: header
   Name: Header, Fields: 2, Actions: 1
   Select binary specification group processor
   Binary data model address for Header element:
   udp.message.header
   Adding fields for Header to unprocessed list: messagelength, messagetype
   Unprocessed binary specification components: messagelength, messagetype, payload
[Step 9] Fetch binary specification components for: messagelength
   Name: Message Length
   Select binary specification type processor
   Binary data model address for Message Length element: udp.message.header.messagelength
   Unprocessed binary specification components: messagetype, payload
[Step 10] Fetch binary specification components for: messagetype
   Name: Message Type
   Select binary specification type processor
   Binary data model address for Message Type element: udp.message.header.messagetype
   Unprocessed binary specification components: payload
[Step 11] Fetch binary specification components for: payload
   Name: Payload, Type: Branch
   Select binary specification rule processor
   Binary data model address for Payload element: udp.message.payload
   Adding branches for Payload to unprocessed list: secondsmessage, addordermessage
   Unprocessed binary specification components: secondsmessage, addordermessage
[Step 12] Fetch binary specification components for: secondsmessage
   Name: Seconds Message, Fields: 1
   Select binary specification group processor
   Binary data model address for Seconds Message element: udp.message.payload.secondsmessage
   Adding fields for Seconds Message to unprocessed list: seconds
   Unprocessed binary specification components: seconds, addordermessage
[Step 13] Fetch binary specification components for: seconds
   Name: Seconds
   Select binary specification type processor
   Binary data model address for Seconds element: udp.message.payload.secondsmessage.seconds
   Unprocessed binary specification components: addordermessage
[Step 14] Fetch binary specification components for: addordermessage
   Name: Add Order Message, Fields: 8
   Select binary specification group processor
   Binary data model address for Add Order Message element: udp.message.payload.addordermessage
   Adding fields for Add Order Message to unprocessed list: timestamp, tradedate, instrument, side, orderid, orderpriority, quantity, price
   Unprocessed binary specification components: timestamp, tradedate, instrument, side, orderid, orderpriority, quantity, price
[Step 15] Fetch binary specification components for: timestamp
   Name: Timestamp, Actions: 1
   Select binary specification type processor
   Binary data model address for Timestamp element: udp.message.payload.addordermessage.timestamp
   Unprocessed binary specification components: tradedate, instrument, side, orderid, orderpriority, quantity, price
[Step 16] Fetch binary specification components for: tradedate
   Name: Trade Date
   Select binary specification type processor
   Binary data model address for Trade Date element: udp.message.payload.addordermessage.tradedate
   Unprocessed binary specification components: instrument, side, orderid, orderpriority, quantity, price
[Step 17] Fetch binary specification components for: instrument
   Name: Instrument
   Select binary specification type processor
   Binary data model address for Instrument element: udp.message.payload.addordermessage.instrument
   Unprocessed binary specification components: side, orderid, orderpriority, quantity, price
[Step 18] Fetch binary specification components for: side
   Name: Side, Values: 2
   Select binary specification type processor
   Binary data model address for Side element: udp.message.payload.addordermessage.side
   Unprocessed binary specification components: orderid, orderpriority, quantity, price
[Step 19] Fetch binary specification components for: orderid
   Name: Order Id
   Select binary specification type processor
   Binary data model address for Order Id element: udp.message.payload.addordermessage.orderid
   Unprocessed binary specification components: orderpriority, quantity, price
[Step 20] Fetch binary specification components for: orderpriority
   Name: Order Priority
   Select binary specification type processor
   Binary data model address for Order Priority element: udp.message.payload.addordermessage.orderpriority
   Unprocessed binary specification components: quantity, price
[Step 21] Fetch binary specification components for: quantity
   Name: Quantity
   Select binary specification type processor
   Binary data model address for Quantity element: udp.message.payload.addordermessage.quantity
   Unprocessed binary specification components: price
[Step 22] Fetch binary specification components for: price
   Name: Price
   Select binary specification type processor
   Binary data model address for Price element: udp.message.payload.addordermessage.price
   Unprocessed binary specification components: NONE
[Step 23] Binary data model complete

Operation of the binary data model compiler 300A results in a generic binary data model when using the above-described process on the normalized binary specification components of the example ITCH universal binary specification. The generic binary data model created for the example ITCH binary communication protocol is referred to herein as “example ITCH binary data model.”

A universal binary specification, such as that described in U.S. patent application Ser. No. 18/046,500 filed on Oct. 13, 2022, the contents of which are incorporated herein by reference in its entirety, can list the required binary fields and rules for interpreting any binary communication protocol, binary data storage format, and/or binary data processing architecture. However, in one or more embodiments, other relatively less generalized binary specifications than the universal binary specification model may exist. Referring now to FIG. 3B, a compiler 300N may exist that ingests a normalized binary specification 100 other than a universal binary specification. Similarly, processors 330e-n that into fashion binary data model group elements, binary data model type elements, binary data model rule elements and binary action elements from binary specification components other than the normalized binary specification components of the universal binary specification may exist. Upon completion, compiler 300N would produce the same generic binary data model as compiler 300A for same binary communication protocol, binary data storage format, and/or binary data processing architecture.

Many binary communication protocols can be specified as a set of binary headers and binary messages. A specialized normalized binary specification that specifies a binary communication protocol in terms of normalized binary headers and normalized binary messages may exist. Referring again to FIG. 3B, a compiler 300B may exist that includes a parser that parses and/or ingests normalized binary specification header components and normalized binary specification message components. Similarly, compiler 300B may include processor 330e that converts binary specification headers into binary data model group elements, binary data model type elements, binary data model rule elements, and binary data model action elements and a processor 330f that processes and converts binary specification message components into corresponding binary data model group elements, binary data model type elements, binary data model rule elements and binary data model action elements. Upon completion, compiler 300B would produce the same generic binary data model as compiler 300A for the same binary communication protocol. Additionally, there are many financial exchanges that use ITCH binary communication protocols. A binary specification optimized for ITCH binary communication protocol messages may exist. A compiler 300C may exist that includes a parser that parses and/or ingests only ITCH binary specification messages and a processor 330g that inserts the binary data model elements for the predetermined binary ITCH headers and converts ITCH binary specification messages into corresponding binary data model group elements, binary data model type elements, binary data model rule elements and binary data model action elements. Upon completion, compiler 300C would produce the same generic binary data model as compilers 300A and 300B for the same ITCH binary communication protocol.

Referring collectively to what is shown in FIGS. 3A and 3B, in one or more embodiments, all binary specification component processors 330 may append binary data model elements to the generic binary data model, but not all binary specification component processors will add further binary specification component identifiers to the unprocessed components list. In FIG. 3A, for example, the normalized binary type processor 330b does not add any identifiers to the unprocessed binary components list. Additionally, some, but not all, processing of normalized binary specification rules will add binary data model elements to the generic binary data model. For example, binary data model branch rules must exist to represent any corresponding generic binary data model branches, but binary data model size rule may be a component of generic binary data type element.

In one or more embodiments, any one or more of the described processes may provide an example of a binary data model compiler, which builds binary data model trees and generic binary data models iteratively, e.g., one step at a time, using an iterative method which continues until all elements of an ordered list of unprocessed components have been processed. One of ordinary skill in the art will appreciate that generic binary data models can be constructed using recursive methods. Recursive methods are repeated applications of the same method(s) or process(es) until a termination condition has been reached. In lieu of the unprocessed elements list, the generic binary data model compilers 300A-N could be designed using recursion where each processor would call the selector directly which would recursively call the respective processor when fashioning each of the child binary elements. Upon completion, a compiler using recursion would produce the same generic binary data model as a compiler using an iterative process for the same binary communication protocol, binary data storage format, and/or binary data processing architecture.

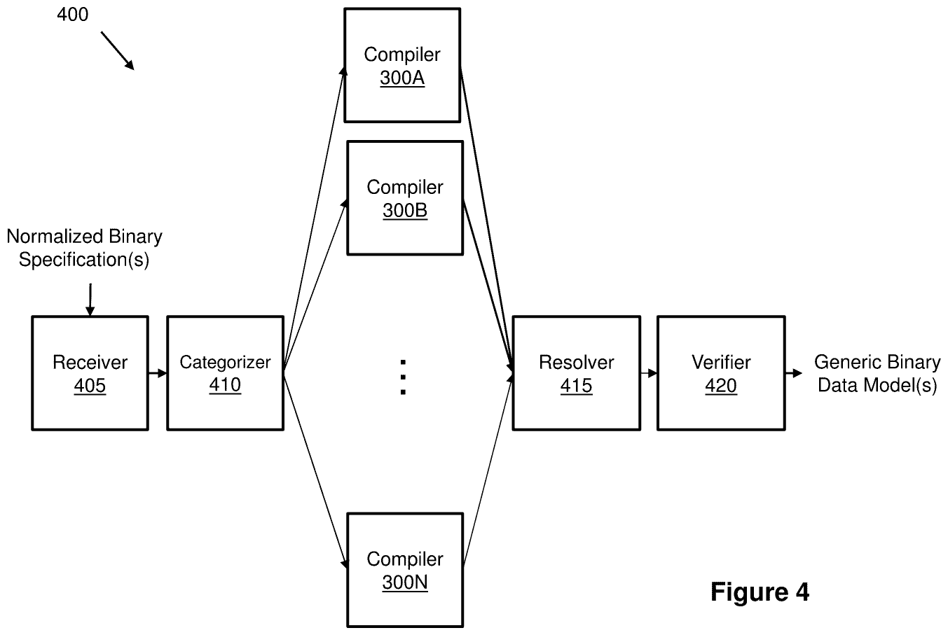

Referring now to FIG. 4, a system 400 incorporating various binary data model compilers 300 into a multiple input binary model compiler is shown. FIG. 4 demonstrates that any binary specification that describes the binary fields and required set of encoding/decoding rules of a binary communication protocol, binary data storage format, and/or binary data processing architecture can be compiled into a generic binary data model using a respective compiler. A collection of compilers is necessary because a universal binary specification is normalized according to the teachings of U.S. patent application Ser. No. 18/046,500 and other different binary specifications may exist and/or be normalized using different methods.

The system 400 may include a receiver 405 configured to ingest a binary specification and a categorizer 410 configured to determine an appropriate binary data model compiler 300A-N to process a given binary specification. The system 400 may include the binary data model compilers 300A and 300B and may also include additional binary data model compilers that fashion generic binary data models from other types of binary specifications according to the principles described herein. In addition to the universal binary specification model of U.S. patent application Ser. No. 18/046,500, other less universal binary specifications may exist and the output of any of the compilers 300A-N is a generic binary data model. Irrespective of the format and the processing method, any binary specification that describes the same set of required binary fields and rules for interpreting a binary communication protocol, binary data storage format, and/or binary processing architecture will be compiled into the same generic binary data model.

The system 400 may also include a resolver 415, a module that calculates generic binary model element addresses. Every generic binary data model element has a unique location within the generic binary data model. Once a binary data model compiler 300 forms the tree(s) of binary data model elements of a generic binary data model, the resolver 415 maps the location of every binary data model element of the binary data model using the locations of the binary data model element's parent elements. An ordered list of the hierarchy of the names of the parent binary data model elements together with the name of binary data model element itself contains the information required to create a unique address for every binary data model element. For example, a binary data model element with Name: “Child” with a single parent binary data model element with Name: “Parent” would have a binary model element address name list as {“Parent”, “Child” } and the example ITCH binary data model element with Name: “Session” could be mapped with {“Udp”, “Packet”, “Session” }.

Alternatively, an ordered list of the hierarchy of the normalized binary specification component identifiers of the parent binary data model elements together with the normalized binary specification component identifier of the binary data model element itself contains the information required to create a unique address for every binary data model element.

There are several methods to represent binary data model element addresses as a unique identifier. In one embodiment, a unique binary model address can be generated by joining the binary data model address element list in order with any delimiter character or signifier like capital letters. For example, the binary data model address of the binary data model element with Name: “Session” with binary data model address element list: {“Udp”, “Packet”, “Session” }, could be declared with hyphens as “udp-packet-session”, in directory format as “Udp/Packet/Session”, in a lower case namespace like identifier as “udp.packet.session”, declared a single identifier as “UdpPacketSession”, declared in capital case in reverse as “SESSIONPACKETUDP”, and/or other similar method. Binary data model addresses are unique within a generic binary data model. In the case of a binary data model with multiple binary data model trees, such as NASDAQ TotalView-ITCH, the protocol binary data model tree would be included in the address. For instance, the binary field with Name: “Timestamp” of the Add Order Message within the UDP binary data model tree of the NASDAQ TotalView-ITCH binary data model may have address: “udp.message.payload.addordermessage.timestamp”. Similarly, the binary field with Name: “Timestamp” of the Add Order Message within the TCP binary data model tree of the NASDAQ TotalView-ITCH binary data model, may be located at binary data model address: “tcp.message.payload.addordermessage.timestamp”. Binary values, characteristics and traits of a binary data model element can be individually addressed and accessed by adding identifying information from the value or characteristic. For example, the value signifying a buy order of the example ITCH binary data model element with Name: “Side” could be signified as “udp.message.payload.addordermessage.side:buy”.

Binary data model element addresses can be made universally unique using binary data model details. A binary data model element address can be made universally unique by appending the generic binary model details to the ordered list that constitutes the tokens of the binary data model address. For example, the organization, protocol type, data type and version from the details of the NASDAQ TotalView-ITCH binary data model may be {“Nasdaq”, “TotalView”, “Itch”, “v5_0” }, and the binary field with Name: “Seconds” of the NASDAQ TotalView-ITCH UDP binary data model tree ordered binary model address name list would contain {“Nasdaq”, “TotalView”, “Itch”, “v5_0”, “Udp”, “Message”, “Payload”, “SecondsMessage”, “Seconds” }, with unique universal binary data model address: “nada.totaliew.itch.v5_0.udp.message.payload.secondsmessage.seconds”.

A generic binary data model may include binary model element dependencies. Any binary field that requires information or data contained in another binary data field for its own decoding has a dependency on another binary data model element, known as a binary dependency. For instance, a binary field may be encoded with a variable number of bytes, where the actual number of bytes of the binary field may be stored or transmitted in a separate binary field. In one embodiment, a generic binary data model dependency may contain the binary generic model address of the binary generic model element that contains the dependency information. For example, FIG. 13 may contain a binary date model rule 1330 with a dependency of Type: Size with a binary rule parameter containing the binary data model address: “sbe.message.memo.length” for the binary dependency. For a binary communication protocol with a variable number of binary messages per packet, like NASDAQ TotalView-ITCH, a binary field may contain the number of binary messages transmitted within the packet. For example, the binary data model element group with Name: “Message” of the example ITCH binary data model has a binary model rule of Type: Count with a binary model rule parameter Dependency: “udp.packet.messagecount”.

Referring again to FIG. 4, the system 400 may also include a verifier 420, a component that verifies the addresses of binary data model element dependencies. A generic binary data model may contain missing or incorrect binary dependencies. Once the resolver 415, creates the binary data element addresses and resolves the binary data element addresses of all binary data model dependencies, the verifier 420, verifies that all dependency binary model elements exist and contain the required information for interpreting the binary field dependencies. For example, a generic binary data rule element for branching may contain a binary dependency. In this case, a generic binary data branch element with Name: “Payload” may have a binary data model rule with a dependency on a binary field with Name: “Message Type” which may possess a corresponding binary data element address: “udp.message.header.messagetype” within the generic binary data model. In this example, the verifier 420 is configured to verify that a generic binary data element exists at binary data model address: “udp.message.header.messagetype” and verifies that the generic binary data element contains the binary value that matches the respective binary model rule parameter. If the generic data model does not include a generic binary data element at generic data model address: “udp.message.header.messagetype”, the verifier may report an invalid dependency error.

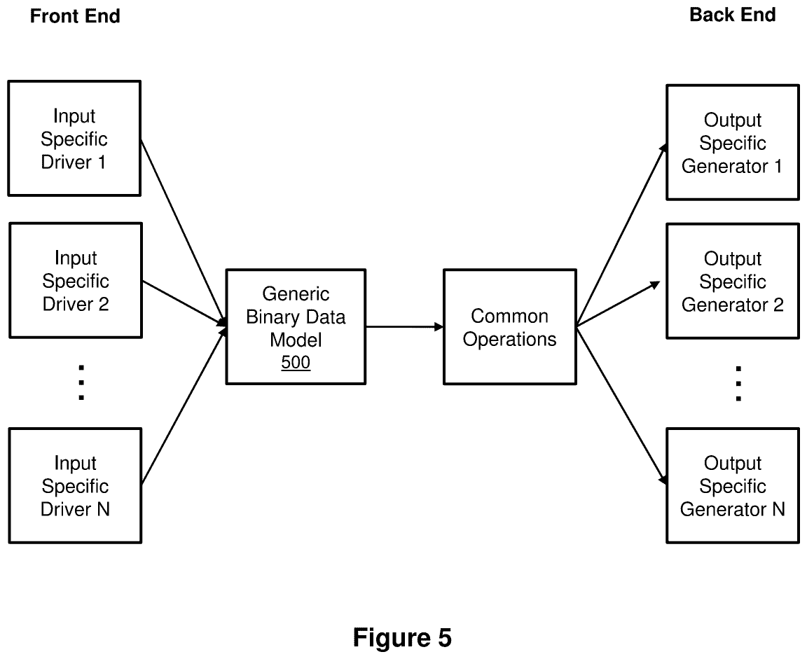

FIG. 5 illustrates generic binary data models as an intermediate representation within an extensible binary data model compiler. FIG. 5 illustrates how generic binary data models 500 achieve a separation of concerns between the various components of a binary data model compiler. Generic binary data models allow the various components of an extensible binary data model compiler, which are input specific drivers, output specific generators, and common operation and analysis facilities, to operate independently. In addition to providing a common intermediate representation for multiple input drivers of the front end of an extensible binary data model compiler, generic binary data models allow common optimization, analysis, and source generation facilities to be shared across multiple output generators in the back end.

Many existing interface description languages use a formal language with a custom syntax as the input for a source generation platform. A source generation platform with multiple output target programming languages may reduce the effort required for using and maintaining binary communication protocols and binary data storage formats. For example, SBE is an open-source interface description language used by several derivatives exchanges for electronic trading. According to the online documentation, SBE is an OSI layer 6 presentation for encoding and decoding binary application messages for low-latency financial applications. SBE uses specific XML schemas to describe binary messages primarily, but also includes some support for composite types and repeating groups. FIG. 13 illustrates SBE XML data elements 1310 describing a composite binary field. The SBE IDL and tools form a one-to-many platform for code generation, providing existing support for several programming languages (Java, C++, Golang, C#, and Rust) and the source code for adding additional languages. However, SBEs source generation model requires translation into the SBE format and SBE's IDL grammar is limited and difficult to use. Furthermore, SBE's code generation facilities are tied directly to the SBE's IDL format and SBE's generated sources tend to be influenced by Java, the original target language. These limitations reduce the efficacy of the SBE source generation model and restrict SBE's adoption to those skilled with SBE's syntax and able to employ the formats of its existing generated source outputs and/or are willing to work within the SBE IDL and tools to design and develop additional source generation capabilities. Kaitai Struct is another IDL centric open-source set of development tools for source generation. From the online documentation, Kaitai Struct is a domain-specific language (DSL) that is designed with one particular task in mind: dealing with arbitrary binary formats. A Kaitai Struct user can create a description of a binary data structure format using a formal language, save it as .ksy file, and compile it with the Kaitai Struct compiler into target programming languages. Kaitai Struct's formal language consists of a custom set of YAML “keys” able to describe an extensive set of real-world binary formats. An example of a .ksy key is “id” which holds the binary group/field identifier of the binary field. Kaitai Struct's formal language includes an “Expression Language”, a simple object-oriented, statically-typed language that gets translated/compiled (e.g. “transpiled”) into any supported target programming language. Kaitai Struct is a one-to-many model for code generation, providing support for several programming languages (Java, C++, C#, Python, etc.) and a plugin architecture for adding additional programming languages. While handling a much larger range of cases and languages than SBE, Kaitai Struct's source generation platform requires translation into the .ksy format, which is difficult and time consuming. Furthermore, the .ksy format may require changes to the original descriptions as Kaitai Struct's generation facilities are tied directly to the IDL format. These limitations reduce the efficacy of the source generation model. For example, Kaitai Struct field names/identifiers are required to be formatted to the rules of the target languages. From Katai Struct documentation:

When transcribing spec based on some existing implementation, most likely you won't be able to keep exact same spelling of all identifiers. Kaitai Struct imposes pretty draconian rules on what can be used as id, and there is a good reason for it: different target languages have different ideas of what constitutes a good identifier.

Additionally, Kaitai Struct's generated programming language code is tightly bound to the Katai Struct IDL. Some programming language design patterns use accessors, and the following is an example of a section within a .ksy file where the IDL definition is used to configure the output of the source generated code for the accessors of the target languages of C++ and JAVA:
seq:
   Id: foo_bar
   getter-Id-cpp: get_foo_bar( )
   getter-Id-java: getFooBar( )

Commingling the programming language source generation instructions and the binary data descriptions within the IDL reduces the separation of concerns and limits the efficacy of a source generation architecture. Additionally, Kaitai Struct uses a list of predefined types for source generation. Binary type traits, which allow binary fields to be composed from several individual empirical traits, provide a more general solution than a pre-defined list of types. For example, the example ITCH binary specification of the present disclosure contains a binary field for transmitting the trade date of an order:

Type [tradedate]
Name: Trade Date
Description: Trade Date
Traits:
   Size: 2
   Translation: Integer
   Signedness: Unsigned
   Memory: Bytes
   Endian: Big
   Date: Days
   Epoch: Unix

Kaitai Struct's formal language might describe the above binary field with Name: “Trade Date” of the example ITCH binary communication protocol as id: “trade_date” with type: “u2” if the “endian” key is set to “be”. Generic binary data model type traits are independent and extensible. The binary type traits of generic binary data models of the present disclosure enable the output specific generators for target programming languages to independently translate the binary field with Name: “Trade Date” as an unsigned big-endian integer and/or as a date depending on the requirements of the target programming language model. In another example, arbitrary binary data may contain optional (nullable) binary fields, i.e. the bytes of the binary field will exist but will be marked as not available or unused. By separating the traits of binary field size and format from the traits describing optionality, binary type traits allow output specific generators to independently implement specific encoder/decoders for optional binary fields with different levels of detail depending on the requirements of the target programming language code. Furthermore, generic binary data model rules are independent and made extensible by binary data model rule parameters. Consequently, generic binary data models of the present disclosure are not limited to a formal language or set of expressions such as Kaitai Struct's “Expression Language”. Generic binary data models, and their extensible binary type traits and extensible binary rules, reduce the limitations of declarative IDL programming language source generation models. An independent intermediate representation, such as the generic binary data model of the present disclosure, removes any dependence on the language or grammar of an interface description language and increases the efficacy of the source generation platform.

Referring again to FIG. 5, input specific drivers of the front end of an extensible binary data model compiler are not limited to processing existing interface description language definitions. For example, the details of the NASDAQ TotalView-ITCH binary communication protocol are not distributed as an IDL; NASDAQ TotalView-ITCH is disseminated using several different human readable PDFs. The methods of creating a universal binary specification outlined in U.S. patent application Ser. No. 18/046,500 filed on Oct. 13, 2022, together with the generic binary data models described in the present disclosure provide an optimal solution for creating additional independent input specific drivers. A respective loader (one of loaders 18a-n of item 10 in U.S. patent application Ser. No. 18/046,500) can be configured for each PDF format describing NASDAQ TotalView-ITCH. A respective loader (one of loaders 18a-n of item 10 in U.S. patent application Ser. No. 18/046,500) and/or a compiler 300N of FIG. 3B can be configured for SBE's XML based IDL and separately for the formal language of Kaitai Struct. For an extensible binary data model compiler, additional loaders or compilers can be independently designed and configured for additional IDLs or other binary description formats. Generic binary data models are a common intermediate representation, enabling all input specific drivers of the front end of an extensible binary data model complier to operate independently. Similarly, generic binary data models enable additional output specific drivers to be independently created for additional target source generation languages. An independent intermediate representation is the central technology of a scalable many-to-many programming language code generation platform.

Generic binary data models are an independent intermediate representation for modeling arbitrary binary communication protocols, binary data storage formats and binary data processing architectures. Generic binary data models may be passed onto other binary data model components for further processing, sent directly to the back end for analysis and/or programing language code generation, or output in a common format for separate analysis or to be used later or a different process. Generic binary data models may be output as XML, text, JSON or directly to programming language source code.

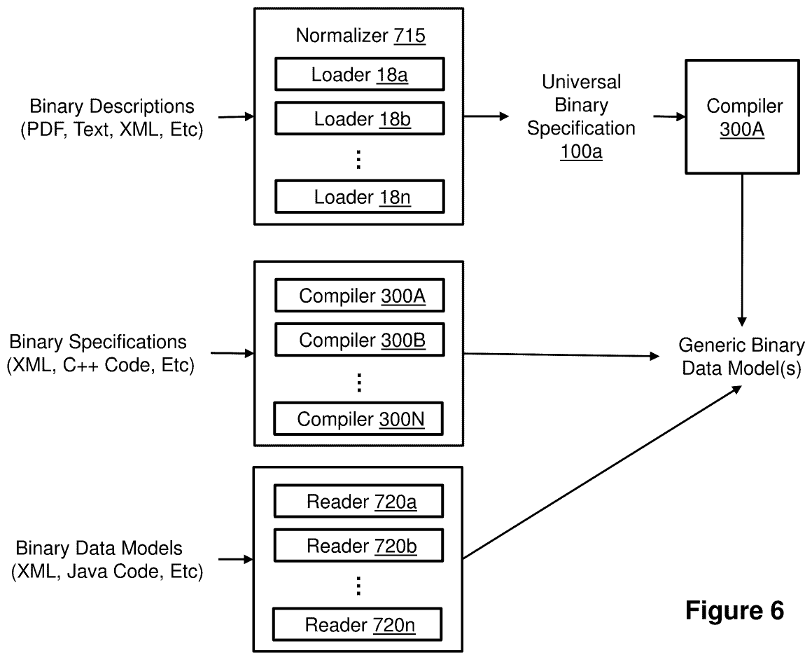

Referring now to FIG. 6, the input specific drivers of the front end of a comprehensive multiple input binary data model compiler are shown. Binary specifications, binary descriptions such as technical notes, design documents, programming language source code, or interface description language definitions and existing binary data models can be fashioned into generic binary data models. A comprehensive multiple input binary data model compiler can ingest binary descriptions, binary specifications, and existing generic binary data models and create generic binary data models. In a first case, as described above, a binary specification such as the universal binary specification model of U.S. patent application Ser. No. 18/046,500 may exist. For this category of binary data model compiler input, the binary data model compiler 300A is operational to ingest the universal binary specification and output a generic binary data model as described herein. Similarly, for binary specifications other than the universal binary specification model of U.S. patent application Ser. No. 18/046,500 a compiler 300B-N may exist and compile other binary specifications into generic binary data models.

A previously compiled binary data model may exist. For this category of binary data model compiler input, the front end of multistage multiple input binary data model compiler may include readers 720, components that read/load a specific binary data model format (XML, text, source code, etc.) and outputs the binary data model as disclosed herein. For example, binary data model reader 720a may ingest a binary data model stored in XML format while reader 720b may ingest a binary data model stored in JSON format.

The comprehensive multiple input binary data model compiler may also include a universal binary specification model normalizer 715 (item 10 in U.S. patent application Ser. No. 18/046,500) that receives binary descriptions and outputs a universal binary specification. The universal binary specification normalizer 715 (item 10 in U.S. patent application Ser. No. 18/046,500) includes loaders 18a-n for different types of binary descriptions. The binary data model 300A may then compile the universal binary specification as disclosed herein into a generic binary data model.

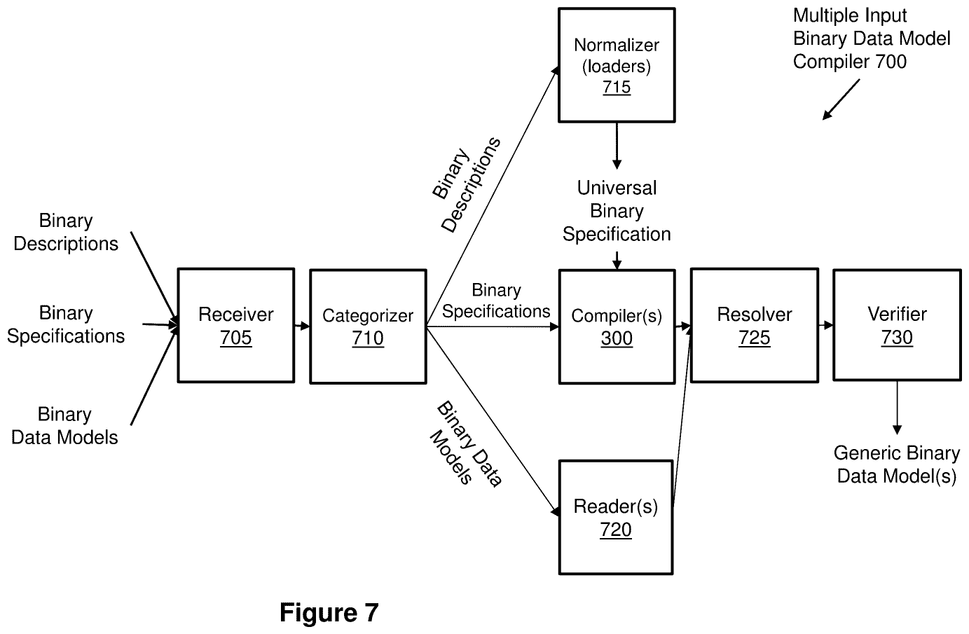

Referring now to FIG. 7, a block diagram of a system is shown, which may represent a comprehensive front end for a multiple input binary data model compiler 700. Multiple input binary data model compiler 700 includes a receiver 705 for receiving various inputs for creating or loading generic binary data models. Multiple input binary data model compiler 700 includes a categorizer 710, a compiler component that categorizes the various inputs of a binary data model compiler and dispatches the binary data model compiler inputs to the relevant input driver from a series of input specific drivers. The categories of inputs for multiple input binary data model compiler 700 are binary descriptions, binary specifications, and/or existing generic binary data models. Multiple input binary data model compiler 700 may also include a resolver 725, a compiler component that calculates generic binary model element addresses and a verifier 730, a compiler component that verifies the binary data model element addresses of any binary dependencies.

Binary descriptions may be inputs to multiple input binary data model compiler 700. The receiver 705 may receive the inputs to the binary data model compiler and identify the inputs as binary descriptions. The categorizer 710 may then categorize the binary descriptions and dispatch the binary descriptions to the respective loaders 18a-n of normalizer 715 (e.g., referred to as item 10 in U.S. patent application Ser. No. 18/046,500). The normalizer 715 (item 10 in U.S. patent application Ser. No. 18/046,500) creates a universal binary specification by normalizing, editing and/or aggregating the information in binary descriptions using the process described in detail in U.S. patent application Ser. No. 18/046,500 filed on Oct. 13, 2022. The binary model compiler 300A compiles the universal binary specification to a generic binary data model, which may be fed to the resolver 725 as described herein.

Specifically, in one or more embodiments, the resolver 725 of FIG. 7 may be one example of resolver 415. Namely, the multiple input binary data model compiler 700 may also include a resolver 725, a module that calculates generic binary model element addresses. Every binary data model element has a unique location within the generic binary data model. Once the binary data model 300 forms the tree(s) of binary data model elements of a generic binary data model, the resolver 725 maps the location of every binary data model element of the binary data model using the locations of the binary data model element's parent elements. An ordered list of the hierarchy of the names of the parent binary data model elements together with the name of the binary data model element itself or an ordered list of the hierarchy of the normalized binary specification component identifiers of the parent binary data model elements together with the normalized binary specification component identifier of the binary data model element itself contains the information required to create a unique address for every binary data model element. For example, a binary data model element with Name: “Child” with a single parent binary data model element with Name: “Parent” would have a binary model element address name list: {“Parent”, “Child” }. There are several methods in the present disclosure for representing binary data model element addresses as a unique identifier.

A binary specification may be an input of the multiple input binary data model compiler 700. The receiver 705 may receive the binary data model compiler input and identify the input as a binary specification. If the binary data model compiler input is identified as universal binary specification, the categorizer 710 may then categorize the binary specification as a universal binary specification and dispatch the binary specification to the universal binary specification compiler 300A. For binary specifications other than universal binary specification, the categorizer 710 may then categorize the binary specification and dispatch the binary specification to a different binary specification compiler 300N able to compile the specific format of the binary specification. The respective compiler compiles the binary specification to the generic binary data model, which may be fed to resolver 725 as described above.

An existing generic binary data model (i.e. previously compiled or otherwise created and output) may be an input to multiple input binary data model compiler 700. The receiver 705 may analyze the received binary data model compiler input and identify the input as an existing generic binary data model. In one or more embodiments, the format of the existing binary data model may be text, XML, JSON, or generated programming language source code, etc. The categorizer 710 may then categorize the input existing binary data model and dispatch the generic binary data model to the reader 720a-n configured to read the specific format of the existing generic binary model. A binary data model reader 720 reads the specific format of the existing binary model which may be XML, JSON, text, or programming language source code, etc. and fashions a generic binary data model which may be fed to the resolver 725 as described herein.

Different binary data model compiler inputs are processed by different input specific drivers of multiple input binary data model compiler 700. Categorizer 710 contains logic that categorizes the generic binary data model compiler inputs and dispatches the inputs to respective input specific drivers. Binary data model inputs may be binary specifications, existing binary data models and/or binary descriptions such as technical notes, design documents, programming language source code, and/or IDL definitions etc. For multiple input binary data model compiler 700, the input specific drivers for binary descriptions are the respective loaders 18a-n of normalizer 715 (e.g., item 10 in U.S. patent application Ser. No. 18/046,500). For multiple input binary data model compiler 700, the input specific drivers for binary specifications are compilers 300A-N which compile various formats of binary specifications into generic binary data models. For multiple input binary data model compiler 700, the input specific drivers for existing binary data models are binary data model readers 720a-n which load different formats of existing binary data models. Once the input specific drivers of the multiple input binary data model compiler 700 produce a generic binary data model from the inputs, the resolver 725 resolves the binary data model element addresses within a generic binary data model, including the addresses of all dependencies, and the verifier 730 verifies that all binary data elements referenced by binary dependencies exist and contain the required information for interpreting the binary field dependencies within a given generic binary data model. The result is a generic binary data model with resolved and verified binary data model dependencies. A generic binary data model is an independent intermediate representation for modeling a binary communication protocol, binary data storage format, and/or binary data processing architecture enabling common optimization, analysis, and generation facilities to be shared across multiple outputs.

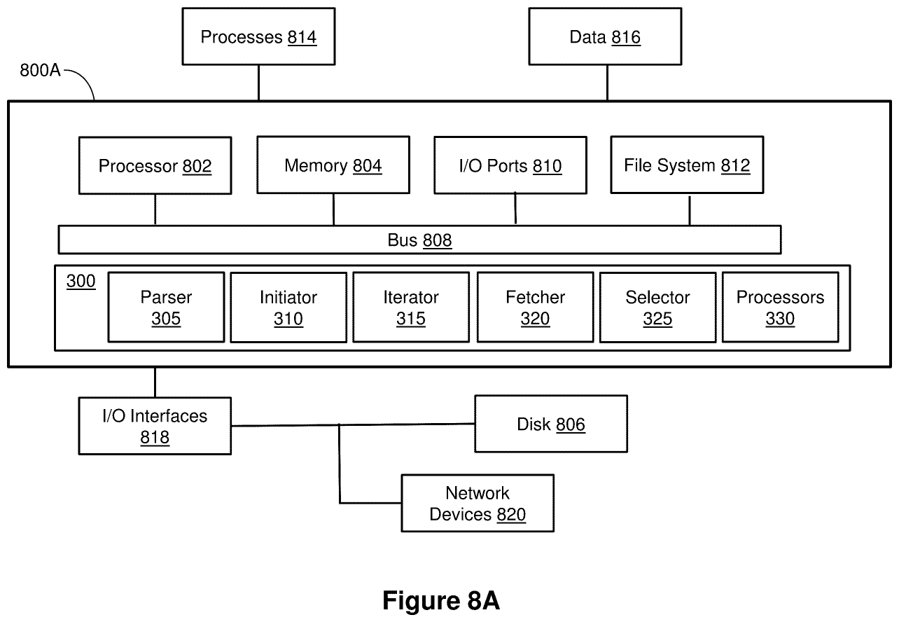

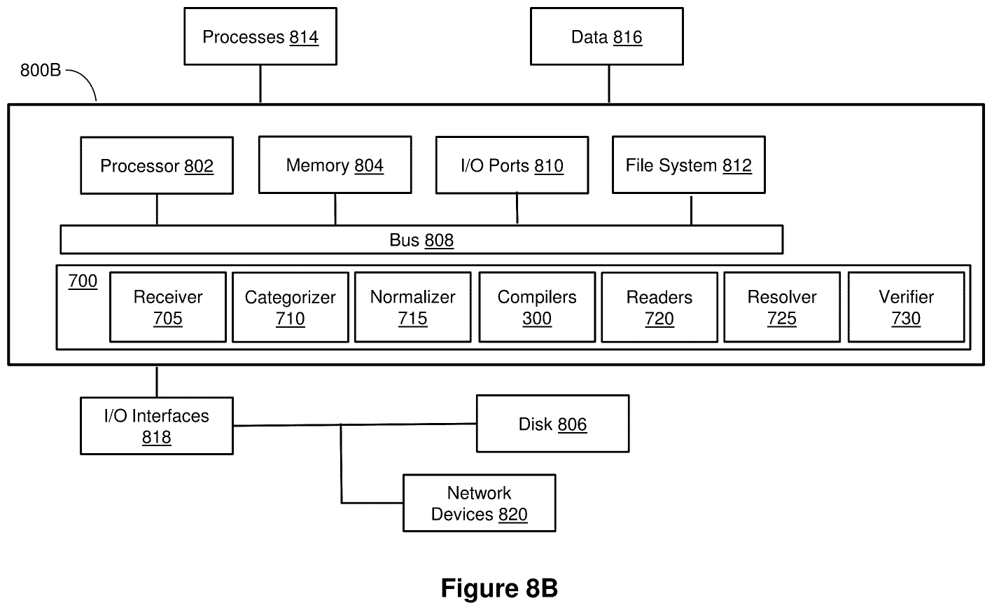

Referring now to FIG. 8A, a block diagram of an exemplary machine 800A for creating a generic binary data model is shown. The machine 800A may be a computer and/or a computer system, which may execute any one or more methods, steps or operations described in the present disclosure. In one or more embodiments, the machine may include a processor 802, a memory 804, 1/O Ports 810, and a file system 812 operably connected by a bus 808.

In one example, the machine 800A may transmit input and output signals via, for example, I/O Ports 810 or I/O Interfaces 818. In the configuration shown by FIG. 8A, machine 800A includes the compiler 300, introduced in FIG. 1. The compiler 300 may be, in one or more embodiments, either the compiler 300A for compiling the universal binary specification 100a as shown in FIG. 3A, or a compiler 300N for compiling a different normalized binary specification 100 as shown in FIG. 3B. The machine 800A includes compiler 300, and its associated components (e.g., the parser 305, the initiator 310, the iterator 315, the fetcher 320, the selector 325, and the processors 330), which function as described earlier for FIGS. 3A and 3B. Thus, binary data model compiler 300, and its associated components, may be implemented in the machine 800A as hardware, firmware, software, or combinations thereof and, thus, the machine 800A and its components may provide means for performing functions described herein as performed by the compiler 300 and its associated components as shown in FIG. 8A.

Still referring to FIG. 8A, the processor 802 can be a variety of various processors including dual microprocessor and other multi-processor architectures. The memory 804 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the machine 800 via, for example, an I/O Interfaces (e.g., card, device) 818 and an I/O Ports 810. The disk 806 can include, but is not limited to, devices like a magnetic disk drive, a solid-state disk drive, a floppy disk drive, a tape drive, a flash memory card, or a memory stick. Furthermore, the disk 806 can include optical drives like a CD-ROM, a CD recordable drive (CD-R drive), a CD rewriteable drive (CD-RW drive), or a digital video ROM drive (DVD ROM). The memory 804 can store processes 814 or data 816, for example. The disk 806 or memory 804 can store an operating system that controls and allocates resources of the machine 800.

The bus 808 can be a single internal bus interconnect architecture or other bus or mesh architectures. While a single bus is illustrated, it is to be appreciated that machine 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The machine 800 may interact with input/output devices via 1/O Interfaces 818 and I/O Ports 810. Input/output devices can include, but are not limited to, a keyboard, a microphone, a pointing and selection device, cameras, video cards, displays, disk 806, network devices 820, and the like. The 1/O Ports 810 can include but are not limited to, serial ports, parallel ports, and USB ports.

The machine 800 can operate in a network environment and thus may be connected to network devices 820 via the 1/O Interfaces 818, or the 1/O Ports 810. Through the network devices 820, the machine 800 may interact with a network. Through the network, the machine 800 may be logically connected to remote devices. The networks with which the machine 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 302.3), token ring (IEEE 302.5), wireless computer communication (IEEE 302.11), Bluetooth (IEEE 302.15.1), Zigbee (IEEE 302.15.4) and the like. Similarly, the network devices 820 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

Referring now to FIG. 8B, an alternative configuration of a machine 800B is shown. Description of like elements shown by FIG. 8A is omitted. The machine 800B includes the multiple input binary data model compiler 700, and its associated components (e.g., the receiver 705, the categorizer 710, the normalizer 715, the compilers 300, the readers 720, the resolver 725, and the verifier 730), which function as described earlier in this disclosure for FIG. 7. Thus, the multiple input binary data model compiler 700, and its associated components, may be implemented in the machine 800B as hardware, firmware, software, or combinations thereof and, thus, the machine 800B and its components may provide means for performing functions described herein as performed by the multiple input binary data model compiler 700 and its associated components.

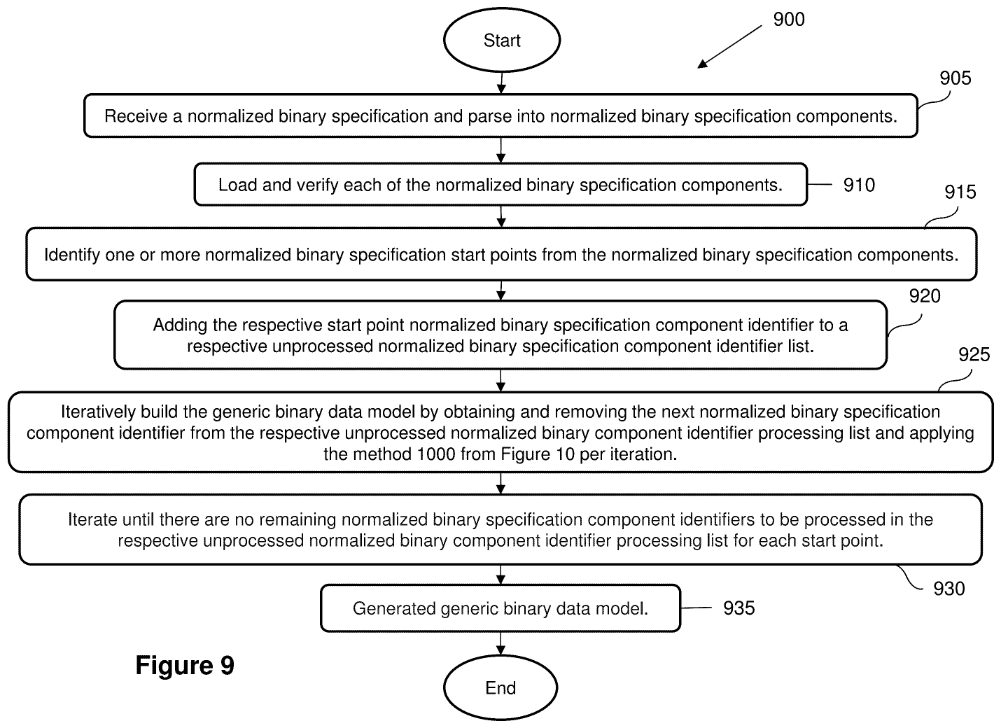

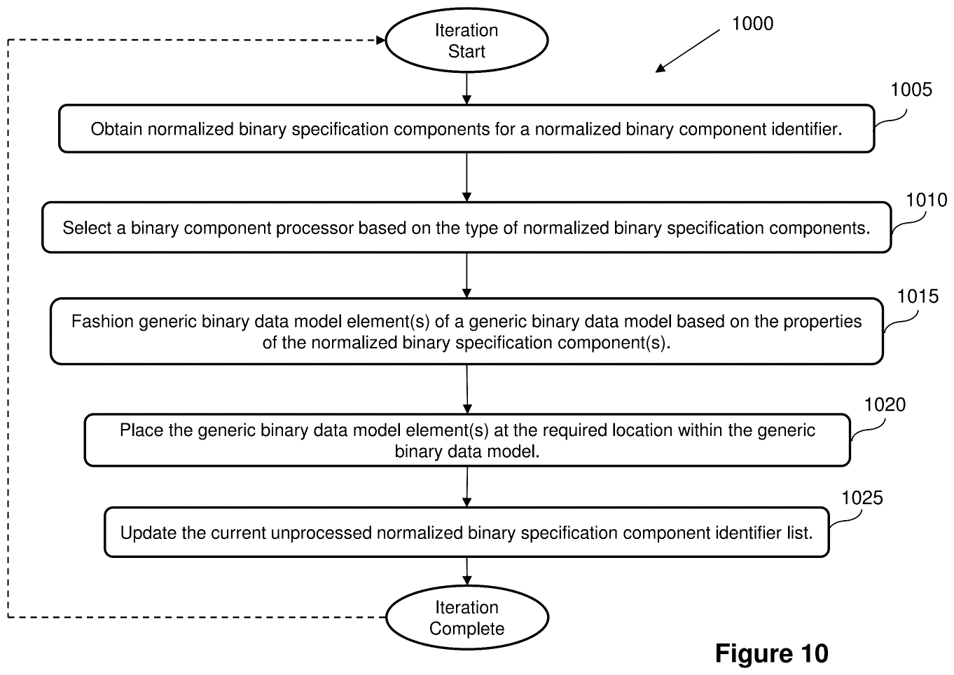

Referring to FIG. 9, a flowchart for a method 900 for creating a generic binary data model, which may be an example of any one or more generic binary data models described in the present disclosure, is shown. In one or more embodiments, one or more operations included in the method 900 may be executed, or at least partially executed, by one or more components included in the machine 800A of FIG. 8A, such as, but not limited to, one or more processors and associated non-volatile memory coupled therewith. The method 900 may create a generic binary data model by, at operation 905, receiving, by a parser, such as the parser 305 of FIG. 3A or 3B, a normalized binary specification, and parsing the normalized binary specification into normalized binary specification components, such as any one or more normalized binary specification components described in the present disclosure. The method 900 may continue, at operation 910, with loading and verifying each of the normalized binary specification components. Method 900 may continue, at operation 915, identifying, by an initiator, such as the initiator 310 of FIG. 3A or 3B, one or more normalized binary specification start points from the normalized binary specification components. In some embodiments, each normalized binary specification start point has a respective normalized binary specification component identifier. The method 900 may continue, at operation 920, when the initiator 310, in one or more embodiments, adds the respective normalized binary specification component identifier to a respective unprocessed normalized binary specification component identifier list. The method 900 may continue, at operation 925, with iteratively building, by an iterator, such as the iterator 315 of FIG. 3A or 3B, the generic binary data model by obtaining and removing a normalized binary specification component identifier from the respective unprocessed normalized binary component identifier processing list. Method 900 fashions binary data model elements of the generic binary data model using the respective unprocessed normalized binary component identifier as described in FIG. 10. The method 900 may continue, at operation 930, by returning to the iterator until there are no remaining normalized binary specification component identifiers to be processed in the respective unprocessed normalized binary component identifier processing list for each of the start points. The method 900 when complete, at operation 935, generates a generic binary data model.

Referring now to FIG. 10, method 1000 is a flow chart of a compiler iteration described in FIG. 3A or 3B and referenced in 925 of method 900. In one or more embodiments, the method 1000 at operation 1005, fetches relevant normalized binary specification components of the normalized binary specification using the normalized binary specification component identifier, by a fetcher, such as the fetcher 320 of FIG. 3A or 3B. The method 1000 may continue, at operation 1010, selecting a processor from multiple processors, using a selector, such as the selector 325 of FIG. 3A or 3B, such as any one of the normalized binary specification group processor 330a, the normalized binary specification type processor 330b, the normalized binary specification rule processor 330c, the normalized binary specification action processor 330d of FIG. 3A, or normalized binary specification component processor 330n of FIG. 3B based on the type of normalized binary specification components. In one or more embodiments, the method 1000 may continue, at operation 1015, when a processor selected by the selector, referred to herein as a “selected processor,” may receive current normalized binary specification components from the normalized binary specification and fashion one or more generic binary data model elements of a generic binary data model. The method 1000 may continue, at operation 1020, when the selected processor places the one or more generic binary data model elements at the required location within the generic binary data model. Method 1000 may continue, at operation 1025, when the selected processor updates the current unprocessed normalized binary specification component identifier list with any additional to be processed binary specification component identifiers. In one or more embodiments, method 1000 may iteratively repeat from operation 1005 to operation 1025 for any number of iterations to, for example, update one or more instances of the current unprocessed normalized binary specification component identifier list one or more times.

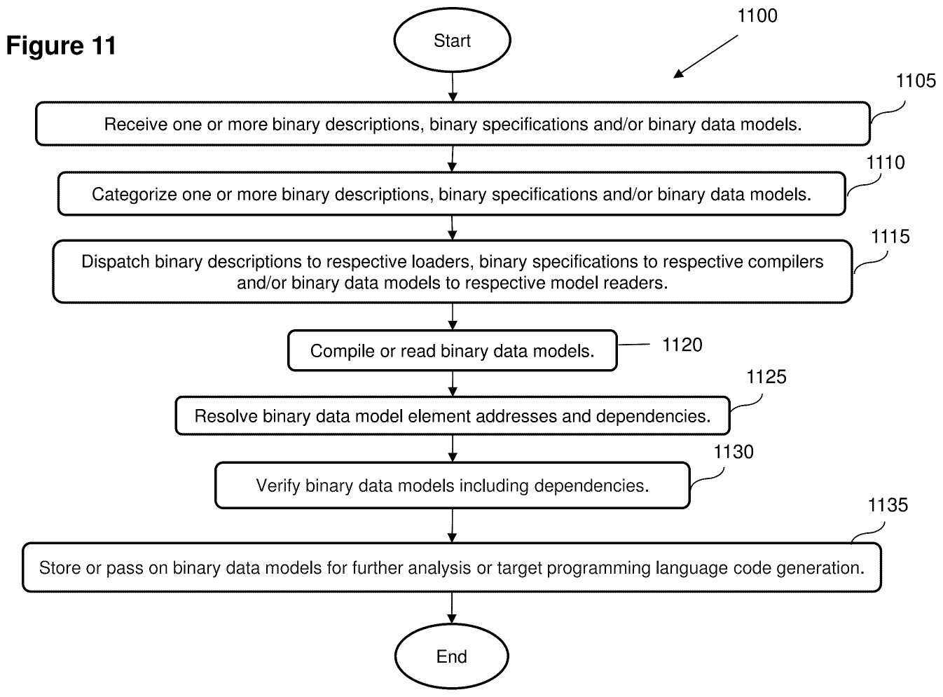

Referring to FIG. 11, a flowchart for method 1100 for creating a generic binary data model, which may be an example of any one or more generic binary data models described in the present disclosure, is shown. In one or more embodiments, one or more operations included in the method 1100 may be executed, or at least partially executed, by one or more components included in the machine 800B of FIG. 8B, such as, but not limited to, one or more processors and associated non-volatile memory coupled therewith. Method 1100 may create a generic binary data model by, at operation 1105, receiving, by a receiver, such as the receiver 705 of FIG. 7, one or more binary descriptions, binary specifications and/or existing binary data models. Method 1100 may continue, at operation 1110, categorizing, by a categorizer, such as the categorizer 710 of FIG. 7, one or more binary descriptions, binary specifications and/or existing binary data models. The method 1100 may continue, at operation 1115, when the categorizer 710 dispatches the binary descriptions to respective loaders, binary specifications to respective compilers and/or binary data models to respective model readers. In some embodiments, each normalized binary specification has a respective compiler 300N. In some embodiments, each binary description has a respective loader 18n of the normalizer 715. In some embodiments, each existing binary data model has a respective reader 720 in FIG. 7. The method 1100 may continue, at operation 1120, binary descriptions are normalized into a universal binary specification and compiled into a binary data model, binary specifications are compiled into binary data models, and/or existing binary data models are read using binary data model readers. The method 1100 may continue, at operation 1125, resolving, by a resolver, such as the resolver 725 of FIG. 7, in one or more embodiments, binary data model element addresses. Method 1100 may continue, at operation 1130, verifying, by a verifier, such as the verifier 730 of FIG. 7, the generic binary data model and any dependencies. Method 1100 may continue, at operation 1135, storing or passing on generic binary data models for further analysis or programming language code generation.

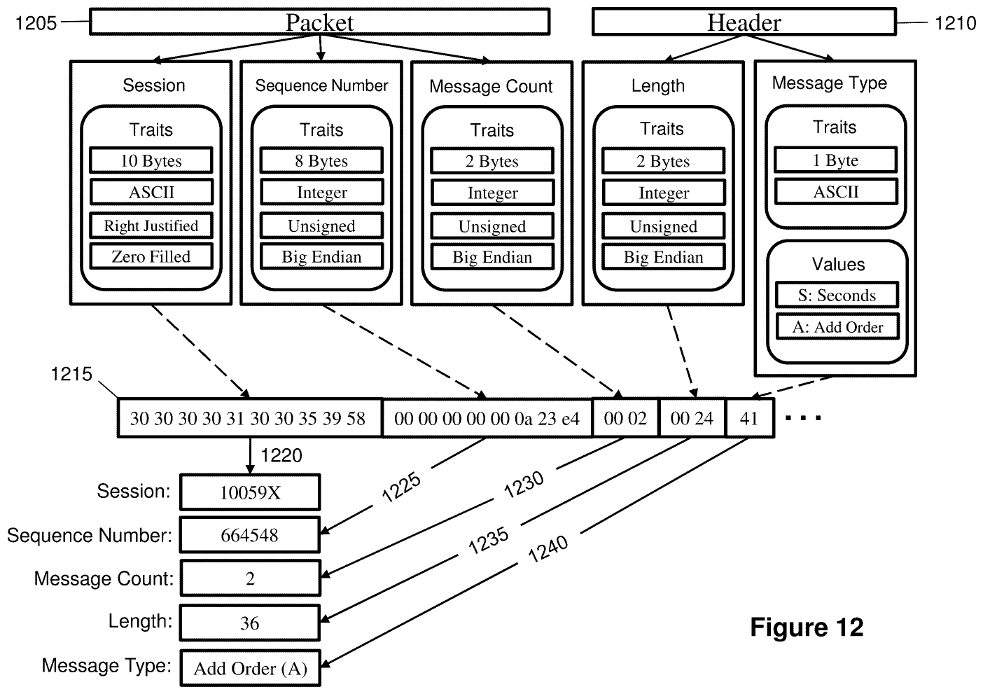

FIG. 12 is a schematic diagram illustrating how a generic binary data model can be used to decode binary data. Specifically, FIG. 12 demonstrates how sequential binary data fields of a generic binary data model overlay sequential bytes of example binary data of the example ITCH binary communication protocol. As shown in FIG. 12, Packet 1205 is a binary data model group element of the generic binary data model compiled from the example ITCH binary specification described earlier in the present disclosure. Packet 1205 includes binary child fields “Session”, “Sequence Number” and “Message Count”. Child field “Session” is a binary data model type element with respective binary type traits for decoding 10 bytes as a right-justified, zero-filled ASCII text. Child field “Sequence Number” is a binary data model type element with respective type traits for decoding an unsigned big-endian integer of 8 bytes. Child field “Message Count” is a binary data model type element with respective type traits for decoding a binary field containing the number of messages to follow as a 2-byte unsigned big-endian integer.

Still referring to FIG. 12, Header 1210 is the next sequential binary data model group element possessing binary fields following the binary data model group element Packet 1205 of the generic binary data model compiled from the example ITCH binary specification. As shown in FIG. 12, binary data model group element Header 1210 has child fields named “Length” and “Message Type”. “Length” is a binary data model type element with respective binary type traits for decoding an unsigned big-endian integer of 2 bytes. “Message Type” is a binary data model type element with respective binary type traits for decoding a single byte as an enumerated ASCII character with 2 possible values containing the message type of the binary message to follow.

In FIG. 12, the binary stream of bytes represented in hexadecimal format 1215 contains binary data of the example ITCH binary communication protocol. Applying the binary type traits of the “Session” field of the generic binary data model of the example ITCH binary data model to the binary data of the example ITCH binary communication protocol, i.e. interpreting the first 10 bytes of the hexadecimal stream of 1215 of FIG. 12 [30 30 30 30 31 30 30 35 39 58] as a right-justified zero-filled ASCII text field, 1220 of FIG. 12, yields a decoded “Session” field: 10059X. The next sequential field of the binary data model group with Name: “Packet” is the binary data model type with Name: “Sequence Number”. Applying the binary type traits of the “Sequence Number” field, i.e. interpreting the next 8 bytes of the hexadecimal stream of 1215 of FIG. 12 [00 00 00 00 00 0a 23 e4] as an 8-byte unsigned big-endian integer field, 1225 of FIG. 12, yields a decoded value of 664548. In this example, 664548 is the sequence number of the first binary ITCH message of the bytes following binary data stream 1215 of FIG. 12. The binary data model type element with Name: “Message Count” is the next and last field of the binary data model group with Name: “Packet”. Applying the binary type traits of the “Message Count” field, i.e. interpreting the next 2 bytes of the hexadecimal stream of 1215 of FIG. 12 [00 02] as a 2-byte unsigned big-endian integer field, 1230 of FIG. 12, yields a decoded “Message Count” of 2. The example hexadecimal stream 1215 contains the initial bytes of an ITCH Packet with 2 ITCH messages. The next decodable sequential fields of the example ITCH binary data model for the example ITCH binary communication protocol are the child fields of binary data model group element Header 1210. The first child binary data model element of Header is the binary data model type element with Name: “Length”. Applying the binary type traits of the “Length” field, i.e. interpreting the next 2 bytes of the hexadecimal stream 1215 of FIG. 12 [00 24], which is [00000000 00100100] in binary, as a 2-byte unsigned big-endian integer field, 1235 in FIG. 12, yields a decoded “Length” field: 36. The next sequential field of the binary data model group with Name: “Header” is the binary data model type with Name: “Message Type”. Applying the binary type traits of the “Message Type” field, i.e. interpreting the next byte of the hexadecimal stream of 1215 of FIG. 12 [41] which in binary format is [00101001] as a single byte ASCII character field, 1240 of FIG. 12, yields a decoded value of “A” which indicates the first ITCH message type is Add Order. The next 36 bytes of the binary data stream 1215 would be the binary fields of an ITCH Add Order Message of the example ITCH binary communication protocol, which are not included in the diagram for brevity.

FIG. 13 is a schematic diagram of an example of an SBE XML with a runtime size dependency and the generic binary data model elements for representing that binary dependency. In FIG. 13, SBE XML data elements 1310 describe a runtime sized text field. A SBE composite data element is a complex type for storing variable length raw data or text. In FIG. 13, the XML elements describe a “Memo” field that is encoded using two child fields. The first child field has name=“length” with SBE primitiveType=“uint8” and a max number of bytes stated as maxValue=“40” followed by another binary field with name=“data” with primitiveType=“char” and characterEncoding=“ASCII”. Normalized binary specification components representing the SBE XML data elements 1310 in FIG. 13, may be created using a loader 18 as described in U.S. patent application Ser. No. 18/046,500 filed on Oct. 13, 2022, specifically configured for reading this format of SBE XML. After the normalizer 715 of multiple input binary data model compiler 700 converts these SBE XML data elements into normalized binary specification components of a universal binary specification, compiler 300A of multiple input binary data model compiler 700 in FIG. 7 may compile the respective normalized binary specification components into elements of a generic binary data model. Generic binary data model elements 1320 of FIG. 13 represent the SBE XML elements of 1310 within a compiled generic binary data model of a SBE binary communication protocol. In binary data model elements 1320, binary data model group element SBE Message has a child binary data model group element with Name: “Memo” with two child binary data model type elements. The first child binary data element of Memo has Name: “Length” and binary type traits for decoding a single byte unsigned integer. The second child binary data model element of Memo has Name: “Data” and binary type traits for decoding ASCII characters and a binary model rule of Type: Size with a binary rule parameter list containing Dependency: “sbe.message.memo.length”, 1330 in FIG. 13. The SBE field represented by the binary data model element with Name: “Length” contains the runtime number of bytes of the binary field to follow. The binary data model element with Name: “Data” uses the binary data model element address of the dependency within the parameters of the relevant binary data model rule to locate and decode the field with Name: “Length.” The binary field with Name: “Length” contains the number of bytes of the binary field with Name: “Data”. Binary data [00000111 01000101 01111000 01100001 01101101 01110000 01101100 01100101] displayed in hexadecimal format in 1340 of FIG. 13 as [07 45 78 61 6D 70 6C 65], may be decoded using the binary type traits of the binary fields with Name: “Length” which yields 7 (bytes) and Name: “Data” which yields a decoded value of “Example” 1350 of FIG. 13 when reading 7 bytes as indicated by the field with Name: “Length”. FIG. 13 illustrates how multiple binary data model elements can be combined to represent a composite type. In some embodiments, a target programming language output generator may include decoders for values of the individual fields of the composite field when generating source code based on the binary data model elements representing the binary field with Name: “Memo”. Other target programming language output specific generators may produce a single decoder for handling the binary field with Name: “Memo”.

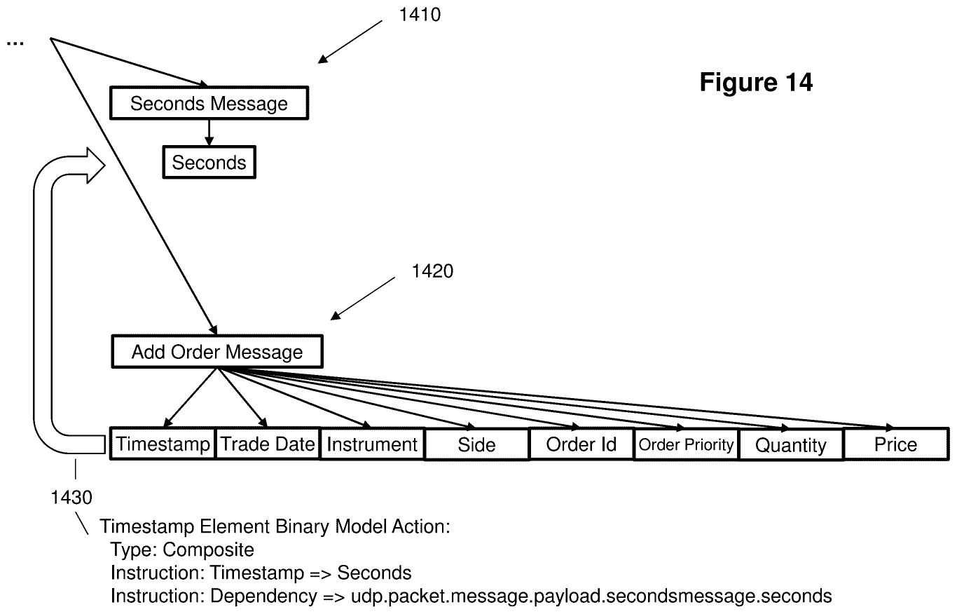

FIG. 14 is a schematic diagram illustrating how a binary data model action can combine binary fields from multiple binary messages to create a composite timestamp. The Seconds Message of the example ITCH binary data model, 1410 of FIG. 14, has a binary data model type element with Name: “Seconds”. The binary data model type element with Name: “Seconds” of the Seconds Message of the example ITCH binary data model has binary data model address: “udp.message.payload.secondsmessage.seconds” and binary type traits which can decode 4 bytes of binary data as the number seconds since Unix Epoch (i.e. the number of non-leap seconds since 0:00:00 UTC on Jan. 1, 1970). In this embodiment of an ITCH binary communication protocol, a Seconds Message may be sent every second with the binary field with Name: “Seconds” containing the number seconds elapsed since Unix Epoch. In FIG. 14, the “Add Order Message” 1420 of the example ITCH binary data model has several binary child fields. The first child field of the Add Order Message is a binary data model type element with Name: “Timestamp” and binary data model address: “udp.message.payload.addordermessage.timestamp”. Binary field with Name: “Timestamp” has binary type traits representing an unsigned 6 bytes big-endian integer which may be decoded to into the number of nanoseconds since the last Seconds Message. The binary field with Name: “Timestamp” of the Add Order Message has a binary data model action 1430 of Type: Composite which contains the instructions to combine the number of seconds elapsed since Unix Epoch and transmitted in the “Seconds” field of the last Seconds Message and the current value of the binary field with Name: “Timestamp”. Some target programming language output specific generators may create an accurate timestamp with nanosecond precision from the instructions of the binary model action 1430 and the decoded values of the respective binary fields.

The example ITCH binary data model contains other binary data model actions which, in one or more embodiments, may be used to represent binary communication protocol behavior. FIG. 12 illustrates the decoding of the sequential binary fields of the binary data model group with Name: “Packet” and the first instance of the binary data model group with Name: “Header” of the example ITCH binary data model compiled from the example ITCH binary specification. The binary data model group element with Name: “Packet” contains a child field element with Name: “Sequence Number”. In FIG. 12, example ITCH binary protocol packets may contain multiple ITCH messages. Each message will have an instance of an ITCH binary header, a binary data model group element with Name: “Header”. The binary data model group element with Name: “Header” only contains binary fields for message length and type, however, implicit in the example ITCH binary communication protocol are individual message sequence numbers. Individual ITCH message sequence numbers can be calculated using the data contained in the binary field with Name: “Sequence Number” of binary data model group element with Name: “Packet” which has binary data model address: “udp.packet.sequencenumber”. To calculate individual message numbers for each ITCH message of the example ITCH binary communication protocol, decode data contained in the binary field with Name: “Sequence Number” for the sequence number of first ITCH message of the packet and increment that value for each following ITCH message. Example ITCH binary data model contains binary data model actions that may store and increment the message sequence number. For example, in one or more embodiments, a binary data model action can assign the value of “664548” to the first message implied in FIG. 12 and calculate “66454” for the second message implied in FIG. 12.

Binary specification rules and binary specification actions may be compiled into generic binary model elements which contain dependencies. Generic binary data model rules and any dependencies within binary data model rule parameters are usually required for accurately interpreting a binary communication protocol, binary data storage format, and/or binary data processing architecture. Binary model actions are not required for parsing binary communication protocol, binary data storage format, and/or binary data processing architecture but may represent complex behavior beyond the fundamental interpretation and/or encoding/decoding of the sequence of bytes that make up binary data. Generally, and as described by any one or more examples and/or embodiments of the present disclosure, “dependency” and/or “dependencies” refer to at least one binary dependency, which defines a binary field that requires information contained in another binary field for its own encoding/decoding. For example, in one or more embodiments, a binary rule parameter or binary action instruction can contain the binary data model address, as described above and as referred to throughout the present disclosure, of another binary data model element as a dependency.

FIGS. 13 and 14 are representative of how “addresses” may be referenced and/or used in connection with any one or more of the embodiments and/or examples described by the present disclosure. Generally, and as used herein, the term “address” and/or “addresses” may refer to the specific location(s) of one or more corresponding binary data model elements where every binary data model element has a unique location within the generic binary data model. Once a compiler, such as any one or more compilers described in the embodiments of the present disclosure, forms one or more trees of elements of a generic binary data model, a resolver, such as the resolver 725 of FIG. 7, maps the location of every binary data model element of the generic binary data model using the locations of the binary data model element's parent elements. Accordingly, an ordered list of the names or identifiers of the hierarchy of parent binary data model elements including the name or identifier of binary data model element contains the information necessary to create a unique address, as described and used herein in the present disclosure, for every binary data model element.

While the figures illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other example methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagram illustrates functional information one skilled in the art may employ to develop logic to perform the illustrated processing. It will be appreciated that in some examples, computer-executable program instructions, such as program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Gamer, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

“Binary data” refers to any data represented in binary form and is a sequence of bits or bytes.

“Binary information” is any information stored, processed, or transmitted as binary data.

A “binary description” is any documentation, technical note, programming language source code, or domain specific language describing any part of a binary communication protocol, binary data file format and/or binary data processing architecture.

A “binary specification” describes the required set of binary fields and rules for encoding/decoding a binary communication protocol, binary data storage format, and/or binary data processing architecture. Binary specifications may optionally contain binary actions for modeling complex behavior.

A “normalized binary specification” is any binary specification created using a normalization or standardization process.

A “normalized binary specification component” contains standardized technical details for a component of a normalized binary specification.

A “binary message” is a binary data structure transmitted over a network used primarily to signal a specific event or update in a binary communication protocol.

A “binary header” is a binary data structure used for relaying information about a binary packet, binary message, binary file or other binary data structure

A “generic binary data model” is an independent intermediate representation for modeling binary data fields, parsing rules and behavior of a binary communication protocol, binary data file format or binary data processing architecture.

A “binary dependency” is any binary field that requires information or data contained in another binary data field for its own encoding/decoding.

What is claimed is:

1. A method for creating a generic binary data model, the method comprising:
receiving, by a parser, a normalized binary specification that describes aspects of a respective binary communication protocol, binary data storage format, or binary data processing architecture, and parsing the normalized binary specification into a plurality of normalized binary specification components;
loading and verifying each of the plurality of normalized binary specification components;
identifying, by an initiator, one or more normalized binary specification start points from the plurality of normalized binary specification components, each normalized binary specification start point having a respective normalized binary specification component identifier, wherein the initiator adds the respective normalized binary specification component identifier to a respective unprocessed normalized binary specification component identifier list;
iteratively building, by an iterator, the generic binary data model by obtaining and removing one or more normalized binary specification component identifiers from the respective unprocessed normalized binary component identifier processing list, wherein:
the iterator is configured to obtain, by a fetcher using the normalized binary specification component identifier, all related normalized binary specification components of the normalized binary specification for each binary specification component;
a selector is configured to select a processor from a plurality of processors based on a type of normalized binary specification component; and
a selected processor is configured to receive a current normalized binary specification component from the normalized binary specification components, fashion a generic binary data model group element of a generic binary data model, place the generic binary data model group element in a required location within the generic binary data model, and update a current unprocessed normalized binary specification component identifier list;
returning to the iterator until there are no remaining normalized binary specification component identifiers to be processed in the respective unprocessed normalized binary component identifier processing list for each of the start points; and
generating the generic binary data model.

2. The method of claim 1, further comprising fashioning a generic binary data model as an independent intermediate representation defined for modeling all types of binary data, including binary communication protocols, binary data storage formats, and binary data processing architectures.

3. The method of claim 1, wherein the normalized binary specification is a universal binary specification and the plurality of processors further comprise one or more of a normalized binary specification group processor, a normalized binary specification rule processor, a normalized binary specification type processor, or a normalized binary specification action processor.

4. The method of claim 1, wherein the selector is configured to select a processor from the plurality of processors based on a normalized binary component, wherein:
when the normalized binary component is a normalized binary specification group, a normalized binary group processor is selected,
when the normalized binary component is a normalized binary specification type, a normalized binary type processor is selected,
when the normalized binary component is a normalized binary specification rule, a normalized binary rule processor is selected, and
when the normalized binary component is a normalized binary specification action, a normalized binary action processor is selected.

5. The method of claim 3, further comprising, by the normalized binary specification group processor:
receiving a normalized binary specification group and a location of a corresponding binary data model parent element;
fashioning a generic binary group model element based on properties of the normalized binary specification group;
converting normalized binary specification traits to binary data model traits for the generic binary data model group element;
fetching any relevant normalized binary specification values, normalized binary specification traits, relevant normalized binary specification rules, and relevant normalized binary specification actions that match an identifier of the normalized binary specification group of the universal binary specification;
converting relevant normalized binary specific values to binary data model values, relevant normalized binary specification rules to binary data model rules, and relevant normalized binary specification actions to binary data model actions for the generic binary data model group element; and
adding the generic binary data model group element to an existing generic binary model as a next child element of the generic binary data model group element at a received binary data model parent element location.

6. The method of claim 5, further comprising, by the normalized binary specification group processor:
adding binary specification component identifiers of respective normalized binary specification group fields and the location of a new binary data model group element within the generic binary data model as a binary data model parent element location to an unprocessed binary component identifier processing list in a sequential order from a normalized binary group fields list.

7. The method of claim 3, wherein the normalized binary specification type processor is configured to:
receiving a normalized binary specification type and a location of a corresponding binary data model parent element;
fashioning a generic binary data model type element based on properties of the normalized binary specification type;
converting normalized binary specification traits to binary data model traits for the generic binary data model type element;
fetching any relevant normalized binary specification values, relevant normalized binary specification rules and relevant normalized binary specification actions that match an identifier of the normalized binary specification type of the normalized binary specification;
converting relevant normalized binary specific values to binary data model values, relevant normalized binary specification rules to binary data model rules, and relevant normalized binary specification actions to binary data model actions for the generic binary data model type element; and
adding the generic binary data model type element to an existing generic binary model as a next child element of the generic binary data model group element at a received binary data model parent element location.

8. The method of claim 3, wherein the normalized binary specification rule processor is configured to:
receiving a normalized binary specification rule and a location of a corresponding binary data model parent element;
fashioning a generic binary rule model element based on properties of the normalized binary specification rule;
converting normalized binary specification rule parameters to binary data model rule parameters for the generic binary rule model element;
fetching any relevant normalized binary specification values, relevant normalized binary specification rules and relevant normalized binary specification actions that match an identifier of the normalized binary specification rule of the normalized binary specification;
converting relevant normalized binary specific values to binary data model values, relevant normalized binary specification rules to binary data model rules, and relevant normalized binary specification actions to binary data model actions for a generic binary data model rule element; and
adding the generic binary data model rule element to an existing generic binary model as a next child element of the generic binary data model group element at a received binary data model parent element location.

9. The method of claim 3, wherein the normalized binary specification rule processor is configured to:
for a binary data model branch rule, resolve any branch binary dependencies; and
add binary specification component identifiers of the branch binary dependencies and a location of a new binary rule model element location within the generic binary data model as a binary data model parent element location to an unprocessed binary component identifier processing list in a sequential order from a normalized binary rules list;
for a binary data model union rule, resolve any union binary dependencies; and
add binary specification component identifiers of the union binary dependencies and the location of a new binary rule model element location within the generic binary data model as a binary data model parent element location to an unprocessed binary component identifier processing list in a sequential order from a normalized binary rules list.

10. The method of claim 3, further comprising, by the normalized binary specification action processor:
receiving a normalized binary specification action and a location of a corresponding binary data model parent element;
fashioning a generic binary action model element based on properties of a normalized binary specification action;
converting normalized binary specification action instructions to binary data model action instructions for the generic binary action model element;
fetching any normalized binary specification values that match an identifier of the normalized binary specification action of the normalized binary specification;
converting normalized binary specific values to binary data model values; and
adding a generic binary data model action element to an existing generic binary model as a next child element of the generic binary data model group element at a received binary data model parent element location.

11. The method of claim 3, wherein the method is executed by a generic binary data model compiler, the method further comprising, by the iterator:
causing iterative repetition of functioning of the generic binary data model compiler for binary specification components in an unprocessed binary component processing list one at a time until there are no more binary specification components to be processed.

12. The method of claim 11, wherein:
if the normalized binary specification contains additional start points, functioning of the generic binary data model compiler is repeated until an unprocessed component list of every start point contains no additional binary specification components.

13. A machine or group of machines for creating a generic binary data model, comprising:
a receiver configured to ingest a binary specification;
a categorizer configured to determine an appropriate compiler to call for a binary specification, determination based on a format corresponding to the binary specification;
a plurality of compilers, each compiler representative of a respective binary specification, wherein each compiler is configured to fashion the generic binary data model from one or more normalized binary specification components of the respective binary specification;
a resolver configured to ingest the generic binary data model from a respective compiler and generate a respective generic binary data model address for each generic binary data model element, the resolver further configured to resolve any dependencies between generic binary data model elements; and
a verifier configured to verify validity of all generic binary data model element dependencies.

14. The machine or group of machines of claim 13, wherein generation of the respective generic binary data model address for each generic binary data model element further comprises:
determining a unique location within the generic binary data model by using the resolver to map a respective location of every generic binary data model element of the generic binary data model by using respective locations of one or more parent elements corresponding to a respective binary data model element.

15. The machine or group of machines of claim 13, wherein generation of the respective generic binary data model address for each generic binary data model element further comprises:
generating an ordered list of parent binary data model elements corresponding to a respective generic binary data model element, wherein the ordered list of parent binary data model elements includes information to create a unique address for every generic binary data model element.

16. The machine or group of machines of claim 13, wherein generation of the respective generic binary data model address for each generic binary data model element further comprises:
generating a universally unique address by using one or more unique identifiers of a plurality of generic binary data model details including one or more of an organization, a division, a protocol type, a data type, a version.

17. The machine or group of machines of claim 16, further comprising:
forming, by a generic binary data model compiler, a tree composed of one or more normalized binary specification components, at least some of which connect with respective parent elements; and
mapping, by a resolver, a location of every binary data model element of the generic binary data model by using locations of parent elements connected at least to some respective binary data model elements.

18. The machine or group of machines of claim 16, further comprising:
verifying, by a verifier, one or more generic binary data model element dependencies, each generic binary data model element dependency representing a field that requires information contained in another field, wherein information includes one or more instances of a unique binary data model element address.

19. The machine or group of machines of claim 18, wherein each generic binary data model element dependency includes information describing:
one or more unique binary data model element addresses, including an initial address, for mapping to a respective binary data model element address, wherein the one or more unique binary data model element addresses include one or more preceding and/or successive addresses relative to the initial address.

20. A system comprising:
a machine or group of machines, each including respective one or more processors, for creating a generic binary data model, including:
a parser configured to receive a normalized binary specification that describes aspects of a respective binary communication protocol, binary data storage format, or binary data processing architecture, and parse the normalized binary specification into a plurality of normalized binary specification components, the parser further configured to load and verify each of the plurality of normalized binary specification components;
an initiator configured to identify one or more normalized binary specification start points from the plurality of normalized binary specification components, each normalized binary specification start point having a respective normalized binary specification component identifier, wherein the initiator adds the respective normalized binary specification component identifier to a respective unprocessed normalized binary specification component identifier list;
an iterator configured to iteratively build the generic binary data model by obtaining and removing one or more normalized binary specification component identifiers from the respective unprocessed normalized binary component identifier processing list, wherein:
the iterator is configured to obtain, by a fetcher using the normalized binary specification component identifier, all related normalized binary specification components of the normalized binary specification for each binary specification component;
a selector is configured to select a processor from a plurality of processors based on a type of normalized binary specification component; and
a selected processor is configured to receive a current normalized binary specification component from the normalized binary specification components, fashion a generic binary data model element of a generic binary data model, place the generic binary data model element in a required location within the generic binary data model, and update a current unprocessed normalized binary specification component identifier list, wherein the iterator is configured to iteratively operate until there are no remaining normalized binary specification component identifiers to be processed in the respective unprocessed normalized binary component identifier processing list for each of the start points and generate the generic binary data model.

21. A machine or group of machines for creating a binary data model, comprising:
a receiver configured to receive one or more binary specifications, one or more binary descriptions including one or more of one or more technical notes, one or more design documents, one or more programming language source files, or one or more interface description language definitions that describe, model or specify a binary communication protocol, binary data storage format, or binary data processing architecture, wherein the receiver is further configured to input one or more existing binary data models;
a categorizer configured to distribute one or more binary descriptions to one or more loaders, one or more binary specifications to one or more compilers, and one or more binary data models to one or more readers, each distribution based at least in part a respective binary specification, binary description, or a binary data model;
a normalizer including one or more loaders configured to receive binary descriptions from the categorizer and output one or more normalized binary specifications to one or more compilers;
one or more compilers configured to receive a respective normalized binary specification from the categorizer or from the normalizer;
one or more readers configured to receive one or more existing binary data models from the categorizer;
a resolver configured to ingest a respective generic binary data model from a respective compiler and generate a respective generic binary data model address for each generic binary data model element, the resolver further configured to resolve any dependencies between generic binary data model elements; and
a verifier configured to verify validity of all generic binary data model element dependencies.

22. The machine or group of machines for creating a generic binary data model of claim 21, wherein the one or more compilers are configured to fashion a generic binary data model based as an independent intermediate representation defined for modeling all types of binary data, including binary communication protocols, binary data storage formats, and binary data processing architectures.
